(19) United States
(12) Patent Application Publication
(10) Pub. No.: US 2014/0171017 A1
(43) Pub. Date: Jun. 19, 2014

(54) BILLING SYSTEM USER INTERFACE TOOL

(71) Applicants: Jerold P. Menezes, Irving, TX (US); Harish D. Korapati, Irving, TX (US)

(72) Inventors: Jerold P. Menezes, Irving, TX (US); Harish D. Korapati, Irving, TX (US)

(73) Assignee: Verizon Patent and Licensing, Inc., Basking Ridge, NJ (US)

(21) Appl. No.: 13/716,611

(22) Filed: Dec. 17, 2012

(51) Int. Cl. H04W 4/26; G06Q 30/04

(52) U.S. Cl. CPC H04W 4/26; G06Q 30/04
USPC 455/406; 705/34

(57) ABSTRACT

One or more devices receive, from multiple business processes, real-time billing data relating to the multiple business processes, wherein the multiple business processes include both mainframe systems and open systems. The one or more devices compile the real-time billing data into summary tables corresponding to metrics for the multiple business processes and store the summary tables corresponding to the metrics for the multiple business processes. The one or more devices receive, from a user device, a request to present a dashboard user interface including particular charts of the multiple business processes and retrieve, from the summary tables, data to populate the particular charts for the dashboard user interface. The one or more devices providing, to the user device, a configuration interface for presentation of the particular charts for the dashboard user interface and providing, to the user device, the data to populate the particular charts for the dashboard user interface.

### BACKGROUND

Telecommunication service providers typically provide multiple types of services to customers. For example, a large telecommunication service provider may provide “wired” services, such as telephone, Internet, or television services, and wireless services for mobile devices. Combining telecommunication usage information for billing and/or analysis can be a complex process. Information must be collected and processing within relatively short intervals to identify trends, trigger alerts, and/or certify outgoing bills. Furthermore, usage information from legacy systems may need to be integrated with information from newer systems to enable consolidated billing and/or analysis.

### BRIEF DESCRIPTION OF THE DRAWINGS

FIG. 1 is a diagram illustrating concepts described herein;

FIG. 2 is a diagram that illustrates an exemplary portion of the service provider network of FIG. 1;

FIG. 3 is a diagram of exemplary components of a device that may be used within the network of FIG. 2;

FIG. 4 is a block diagram of exemplary functional components of a billing analyzer module of the network of FIG. 2;

FIG. 5 is a block diagram of exemplary functional components of a dashboard user interface of the network of FIG. 2;

FIG. 6 is a sample screen presentation for a billing alert dashboard according to an implementation described herein;

FIG. 7 is a sample table structure that may be used to store alert configurations for each chart in the billing alert dashboard of FIG. 6;

FIG. 8A is a sample screen presentation for a billing trend dashboard;

FIG. 8B is a sample dashboard configuration tool for configuration of the billing trend dashboard of FIG. 8A;

FIGS. 9A-9D are sample detailed chart configuration graphical user interfaces (GUIs) for the dashboard configuration tool of FIG. 8B;

FIG. 10 is a sample screen presentation for a consolidated billing system dashboard according to an implementation described herein;

FIGS. 11A-11B provide a sample screen presentation for a process detail GUI for the tracking map of FIG. 10;

FIG. 12 is a diagram that illustrates another exemplary portion of the service provider network of FIG. 1, according to another implementation described herein;

FIG. 13 is a block diagram of exemplary functional components of the billing analyzer module of FIG. 12;

FIG. 14 is a block diagram of exemplary functional components of the scheduler/report generator of FIG. 13;

FIG. 15 is a block diagram of exemplary functional components of the certification user interface of FIG. 12;

FIGS. 16A-16C provide a sample screen presentation for a billing certification dashboard;

FIG. 17 is a sample screen presentation of a search interface for the billing certification dashboard;

FIG. 18 is a block diagram of a billing feeds processor according to an implementation described herein;

FIGS. 19A-19C provide exemplary user interfaces that may be generated by the reports engine of FIG. 18; and

FIG. 20 is a flowchart of an exemplary process for providing a billing system user interface tool, according to an implementation described herein.

### DETAILED DESCRIPTION OF PREFERRED EMBODIMENTS

The following detailed description refers to the accompanying drawings. The same reference numbers in different drawings may identify the same or similar elements.

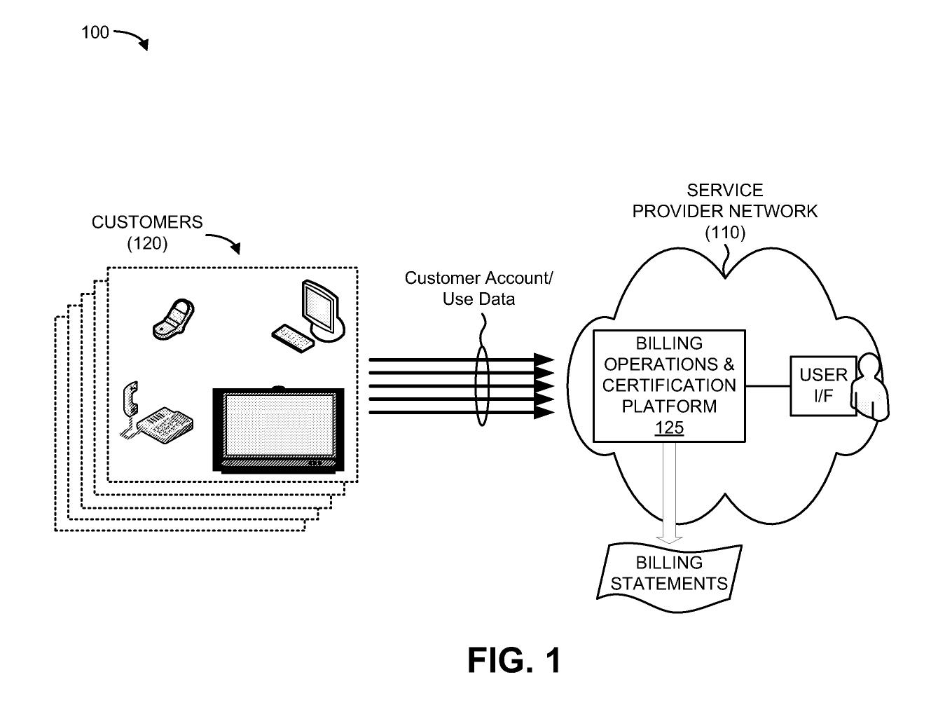

FIG. 1 is a diagram illustrating concepts described herein. A service provider network 110 may provide services, such as telecommunications and related services, to customers 120. Service provider network 110 may include a proprietary environment which represents computing systems used by a corporation or another entity Service provider network 110 may include, for example, one or more private local area networks (LANs). Services for customers 120 may include, for example, television-related services, Internet provider services, telephone services, and/or wireless communication services. In addition, service provider network 110 may include billing systems, data mining systems, Web servers, call center support systems, order tracking systems, or other systems that may interact with or be used to interact with customers 120.

Service provider network 110 may, for example, collect customer account and/or usage data, relating to each of customers 120, to generate bills for services and to monitor customer activity. In one implementation, service provider network 110 may include a billing operations and certification platform 125 that receives data from multiple systems (e.g., television systems, internet services systems, telephone systems, wireless communications systems, etc.) within service provider network 110. Billing operations and certification platform 125 may include processes requiring certification of bills (e.g., prior to issuing to customers) and other internal supervisory functions.

Systems and/or methods described herein may provide user interfaces to supervise activities of multiple systems affecting billing operations and certification platform 125. In one implementation, devices may receive, from multiple business processes, real-time billing data relating to the multiple business processes. The multiple business processes may include, for example, both mainframe systems and open systems for different telecommunications services. The devices may compile the real-time billing data into summary tables corresponding to metrics for the multiple business processes and may store the summary tables corresponding to the metrics for the multiple business processes. The devices may receive, from a user device, a request to present a dashboard user interface including particular charts of the multiple business processes and retrieve, from the summary tables, data to populate the particular charts for the dashboard user interface. The devices may provide, to the user device, a configuration interface for presentation of the particular charts for the dashboard user interface and may provide, to the user device, the data to populate the particular charts for the dashboard user interface.

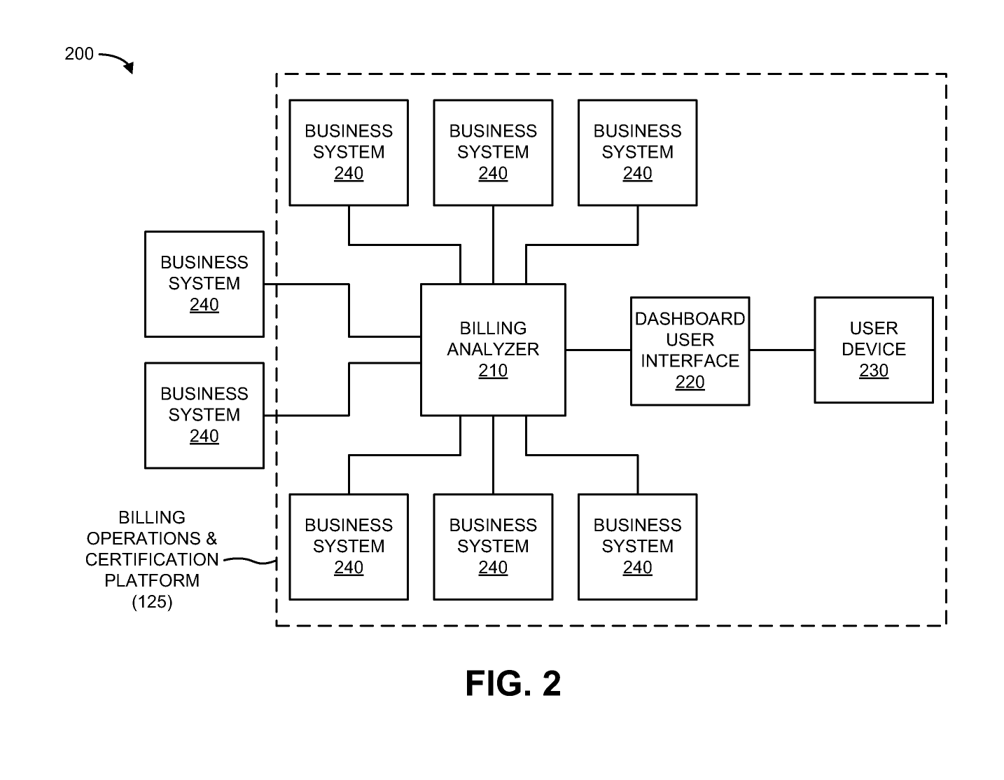

FIG. 2 is a diagram that illustrates an exemplary portion 200 of service provider network 110. As shown in FIG. 2, service provider network 110 may include billing operations and certification platform 125 that includes a billing analyzer module 210, a dashboard user interface module 220, and a user device 230. Service provider network 110 may also include a variety of business systems 240 within and outside of billing operations and certification platform 125 that can feed data to billing analyzer module 210.

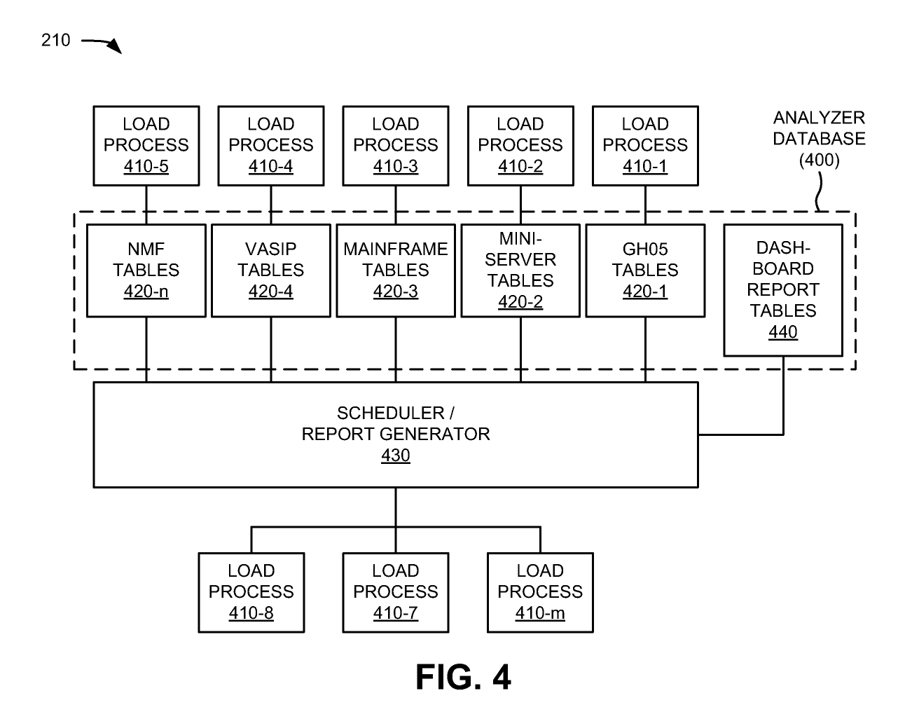

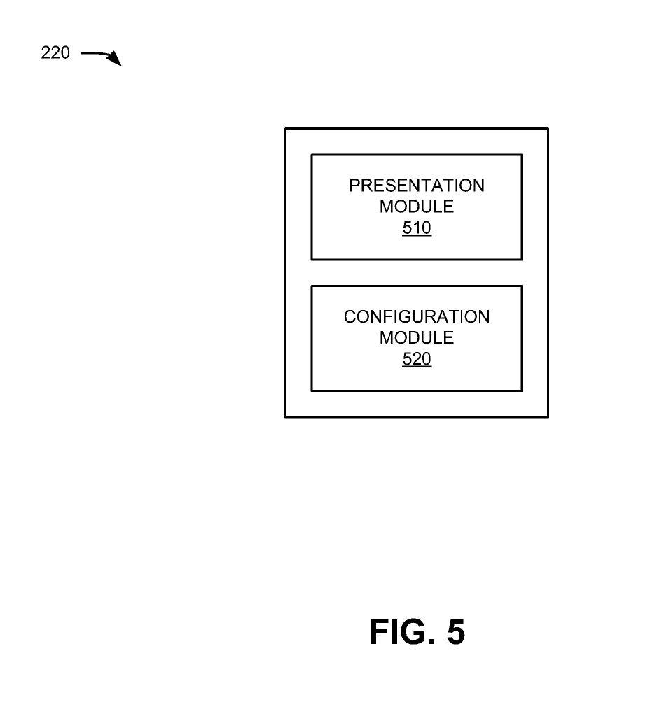

Billing analyzer module 210 may include one or more server devices, or other types of computation or communication devices, that gather, process, search, and/or provide information in a manner described herein. For example, billing analyzer module 210 may receive data from business systems 240, synthesize the data, and generate metrics that are relevant to business operations. Billing analyzer module 210 may process the data and populate summary information in respective tables which can be input for dashboard user interface module 220. Billing analyzer module 210 is described further below in connection with FIGS. 4 and 5.

Dashboard user interface module 220 may include combination of hardware and software to provide user access to summary information from billing analyzer module 210. For example, dashboard user interface module 220 may showcase the trending of real-time billing metrics, as well as provide alerts of any deviation in trending from one period over another. Dashboard user interface module 220 may include, for example, an application designed to easily add or remove trends from the dashboard with just configuration of a new chart via a web page interface. Dashboard user interface module 220 may have separate modules to separately track alerts, track trends, and track combined billing metrics. Dashboard user interface module 220 is described further below in connection with FIGS. 5-11.

User device 230 may include one or more computing devices, servers, or other types of computation or communication devices, that provide secure internal access to dashboard user interface module 220. User device 230 may, for example, allow users (e.g., employees of a service provider) to communicate with components of billing operations and certification platform 125 via private secure connections. For example, in one implementation, user device 230 may include a web browser. Users may use user device 230 to submit configuration settings, view real-time data, monitor particular metrics, etc. related to one or more components of billing operations and certification platform 125.

Business systems 240 may include profile, billing, and/or production processing systems that generate data. Generally, business systems 240 may include any combination of databases, servers, processes, or protocols used to accomplish a business objective. One example of a business system is a billing system that may store user account or service information and handle processes such as invoice generation, payment tracking, rebate tracking, etc. The billing system may be a physically distributed system implemented by a number of computer devices. Business systems 240 may include multiple types of platforms. For example, business systems 240 may include billing systems from multiple different platforms, such as mainframe platforms, open platforms (e.g., Unix, Linux, etc.), etc., and multiple different services (e.g., different telecommunications services, such as wired and wireless services). Each of business systems 240 may generate data at different intervals, on a cyclic and/or ad hoc basis. For example, some business systems 240 may generate monthly data compilations, while other business systems 240 may generate data incrementally. In some instance, business systems 240 may generate data in binary code, while in other business systems 240 may generate numeric data. In another implementation, business systems 240 may include internal systems for managing other business systems, such as certification, operations, and/or reporting systems for other business systems 240.

Although FIG. 2 shows exemplary components of network portion 200, in other implementations, network portion 200 may include fewer, different, differently-arranged, or additional components than those depicted in FIG. 2. Alternatively, or additionally, one or more components of network portion 200 may perform one or more other tasks described as being performed by one or more other components of network portion 200.

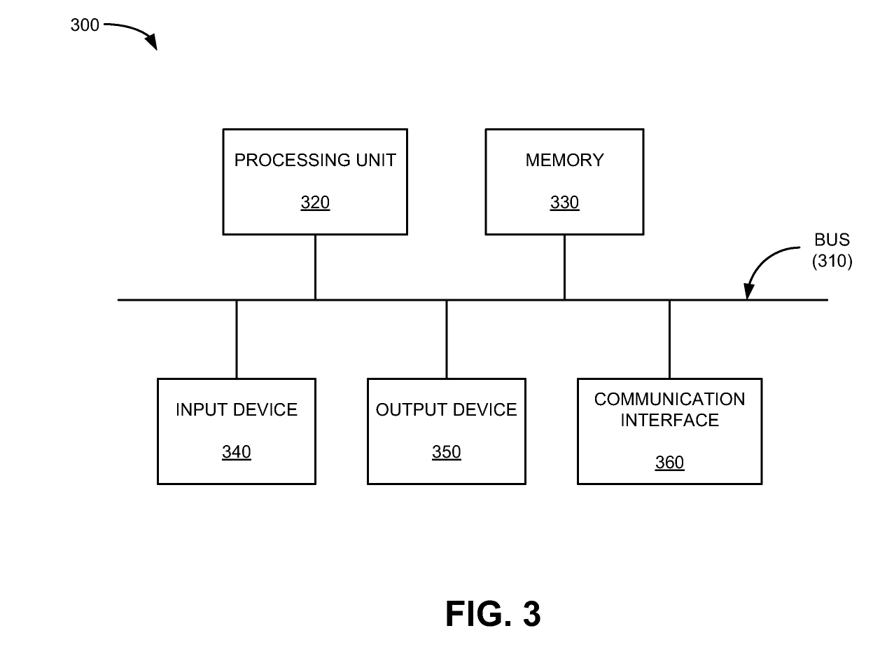

FIG. 3 is a diagram of exemplary components of a device 300. Device 300 may correspond to billing analyzer module 210, dashboard user interface module 220, user device 230, business systems 240, and/or other components described herein. Each of billing analyzer module 210, dashboard user interface module 220, user device 230, and business systems 240 may include one or more devices 300. As shown in FIG. 3, device 300 may include a bus 310, a processing unit 320, a memory 330, an input device 340, an output device 350, and a communication interface 360.

Bus 310 may permit communication among the components of device 300. Processing unit 320 may include one or more processors or microprocessors that interpret and execute instructions. In other implementations, processing unit 320 may be implemented as or include one or more application specific integrated circuits (ASICs), field programmable gate arrays (FPGAs), or the like.

Memory 330 may include a random access memory (RAM) or another type of dynamic storage device that stores information and instructions for execution by processing unit 320, a read only memory (ROM) or another type of static storage device that stores static information and instructions for execution by processing unit 320, and/or some other type of magnetic or optical recording medium and its corresponding drive for storing information and/or instructions.

Input device 340 may include a device that permits an operator to input information to device 300, such as a keyboard, a keypad, a mouse, a pen, a microphone, one or more biometric mechanisms, or the like. Output device 350 may include a device that outputs information to the operator, such as a display, a speaker, etc.

Communication interface 360 may include a transceiver (e.g., a transmitter and/or receiver) that enables device 300 to communicate with other devices and/or systems. For example, communication interface 360 may include mechanisms for communicating with other devices, such as other devices of network 100 or another device 300.

As described herein, device 300 may perform certain operations in response to processing unit 320 executing software instructions contained in a computer-readable medium, such as memory 330. A computer-readable medium may include a non-transitory memory device. A memory device may include space within a single physical memory device or spread across multiple physical memory devices. The software instructions may be read into memory 330 from another computer-readable medium or from another device via communication interface 360. The software instructions contained in memory 330 may cause processing unit 320 to perform processes described herein. Alternatively, hardwired circuitry may be used in place of or in combination with software instructions to implement processes described herein. Thus, implementations described herein are not limited to any specific combination of hardware circuitry and software.

Although FIG. 3 shows exemplary components of device 300, in other implementations, device 300 may include fewer components, different components, differently arranged components, or additional components than depicted in FIG. 3. As an example, in some implementations, input device 340 and/or output device 350 may not be implemented by device 300. In these situations, device 300 may be a “headless” device that does not explicitly include an input or an output device. Alternatively, or additionally, one or more components of device 300 may perform one or more other tasks described as being performed by one or more other components of device 300.

FIG. 4 is a block diagram of exemplary functional components of billing analyzer module 210. As shown, billing analyzer module 210 may include an analyzer database 400 which is fed by a number of load processes 410-1 through 410-m (referred to herein collectively as “load processes 410” and generically as “load process 410”), and a scheduler/report generator 430. Analyzer database 400 may include multiple tables 420-1 through 420-n (referred to herein collectively as “tables 420” and generically as “table 420”), and dashboard report tables 440. Depending on the implementation, billing analyzer module 210 may include additional, fewer, or different functional components than those illustrated in FIG. 4.

Analyzer database 400 may generally store information fed to billing analyzer module 210 from business systems 240. Analyzer database 400 may provide a real-time repository for data relating to business processes in billing operations and certification platform 125.

Load processes 410 may provide a common format for data fed from business systems 240. For example, load processes 410 may receive and format data for storage in respective tables 420. Data may include, for example, billing process data from a particular business systems 240. Thus, in one implementation, each of load processes 410 may update a particular table 420 (or set of tables) within analyzer database 400. In another implementation, load process 410 may receive data that defines how other data from load processes 410 may be summarized. For example, load process 410 may identify particular data fields for certification measurements, operations metrics, and/or reports that can be used by scheduler/report generator 430 to generate summary report tables. Thus, in some instances, load processes 410 may not feed into a particular table 420, but instead may feed directly to scheduler/report generator 430.

Tables 420 may include formatted data received from load processes 410. For example, tables may include may include data fields that may represent process metrics and/or actual bill data relating to billing operations and certification platform 125.

Scheduler/report generator 430 may use data from tables 420 to generate and update reports for dashboard reports tables 440. For example, scheduler/report generator 430 may generate particular tables for dashboard report tables 440 based on configuration tables that identify particular feed files and/or metrics to be presented by dashboard user interface module 220. Scheduler/report generator 430 may extract/receive data from tables 420 based on the configuration tables and generate metric-specific tables for dashboard reports tables 440.

Dashboard report tables 440 may include reports generated by scheduler/report generator 430. Dashboard report tables 440 may be overwritten/updated at regular intervals and/or as new data is recognized by scheduler/report generator 430. Some or all of the tables in dashboard report tables 440 may be retrieved, for example, by dashboard user interface module 220 to populate a dashboard presentation for user device 230. Dashboard report tables 440 may include data to support presentation of particular reports and charts by dashboard user interface module 220. For example, dashboard report tables 440 may include a trends of particular metrics related to billing processes. Exemplary tables in dashboard report tables 440 may include payment trends (e.g., in relation to due dates), adjustment trends (e.g., non-standard changes from standard service rates), promotion proration trends (e.g., temporary changes from standard service rates); new charges alert trends (e.g., new charges exceed a threshold over previous bills); value added services trends (e.g., charges for non-standard service options), etc. New tables for dashboard report tables 440 may be configured by users to support presentation of additional trends/reports by dashboard user interface module 220.

FIG. 5 is a block diagram of exemplary functional components of dashboard user interface module 220. As shown, dashboard user interface module 220 may include a presentation module 510 and a configuration mode 520. Depending on the implementation, dashboard user interface module 220 may include additional, fewer, or different functional components than those illustrated in FIG. 5.

Presentation module 510 may provide a visual framework for presenting data from dashboard report tables 440. In one implementation, the presentation module 510 for dashboard user interface module 220 may be based on an ASP.NET framework with Telerik® Silverlight controls on an Oracle® platform.

Configuration module 520 may include display controls to allow a user to selectively present charts and/or other information from dashboard report tables 440. For example, configuration module 520 may receive configuration settings from a dashboard user (e.g., via user device 230) and apply the configuration settings to selected data for presentation. Configuration module 520 may also include, for example, an alerts component to receive alert settings, monitor particular data based on the alert settings, and generate alerts (e.g., email, SMS message, etc.) when the monitored data matches the alert settings.

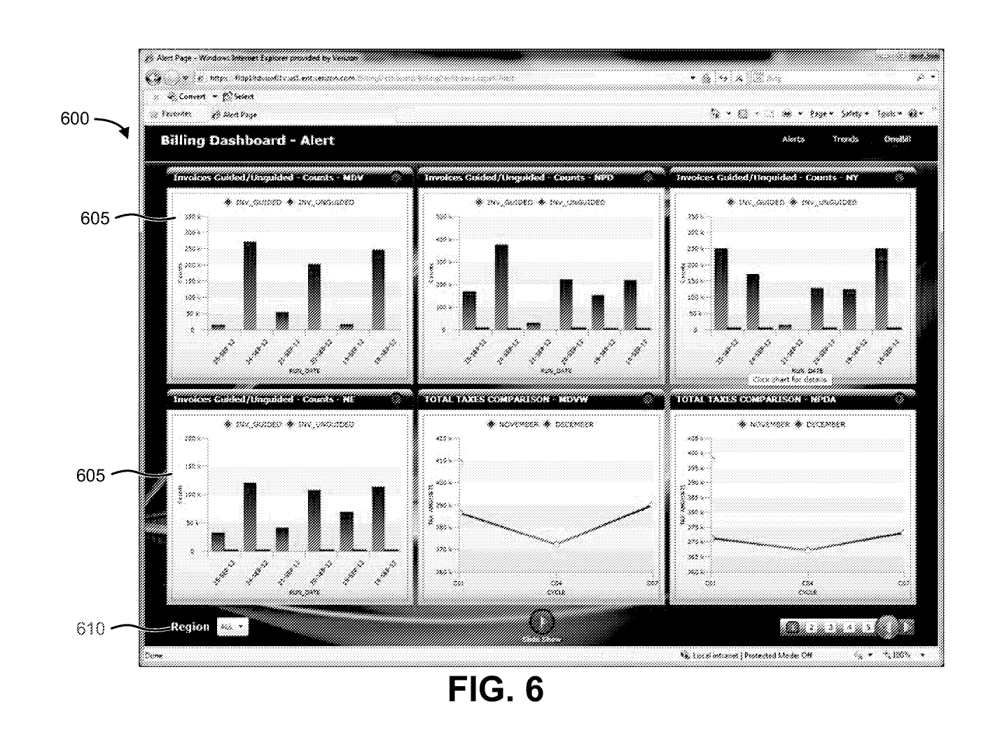

FIG. 6 provides a sample screen presentation for a billing alert dashboard 600. As shown in FIG. 6, billing alert dashboard 600 may be included within a web browser window. Billing alert dashboard 600 may present alerts for multiple different systems that may be configured, for example, as charts 605 in a single screen view. Thus, billing alert dashboard 600 may showcase all metrics for spotting outliers and trends in data. In one implementation, outliers may be categorized as in “Red” or “Yellow” alerts within each chart 605. For example, every metric could have an alert wherein a range of thresholds for the “Red” or “Yellow” limits are pre-defined. If a metric trending falls within the “Red” or “Yellow” warning limits, then the metric would be shown under an assigned alert category in billing alert dashboard 600.

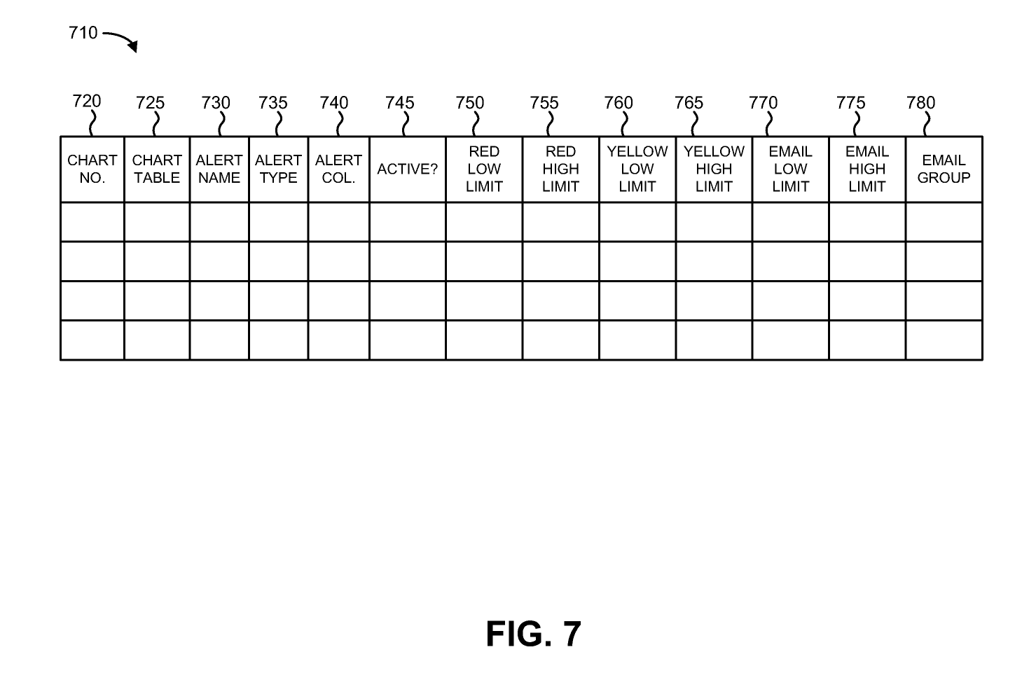

FIG. 7 provides a sample table structure 710 that may be used to store alert configurations for each chart 605 in billing alert dashboard 600. The alert configurations may be entered in table structure 710 having following fields: chart number 720, chart table 725, alert name 730, alert type 735, alert column 740, active indication 745, red low limit 750, red high limit 755, yellow low limit 760, yellow high limit 765, email low limit 770, email high limit 775, and email group 780.

Chart number 720 may indicate a particular unique number for one of charts 605. The unique number may correspond, for example, to a particular display position within billing alert dashboard 600. Chart table 725 may include a name of table from which alert metrics are to be measured. Names in chart table 725 may correspond to, for example, names of tables include in dashboard report tables 440.

Alert name 730 may include the name of a particular alert and/or metric that is being monitored. Alert name 730 may be presented, for example, as a title in each respective chart 605. Alert type 735 may include an indication of alert significance, such as critical, information only, action required, etc.). Alert column 740 may include an indication of a particular column (e.g., in the chart identified in chart table 725) from which data is to be monitored. Active indication 745 may include an indication (e.g., Yes/No) of whether the particular alert configuration is active.

Red low limit 750 may include a low threshold value for which data (e.g., data in the column identified in alert column 740) may trigger a “Red” or high-level alert. Red high limit 755 may include a high threshold value for which data (e.g., data in the column identified in alert column 740) may trigger a “Red” or high-level alert. In some implementations, no limit may be defined for one of red low limit 750 or red high limit 755.

Yellow low limit 760 may include a low threshold value for which data (e.g., data in the column identified in alert column 740) may trigger a “Yellow” or lower-level alert. Yellow high limit 765 may include a high threshold value for which data (e.g., data in the column identified in alert column 740) may trigger a “Yellow” or lower-level alert. In some implementations, no limit may be defined for one or more of yellow low limit 760 or yellow high limit 765.

Email low limit 770 may include a low threshold value for which data (e.g., data in the column identified in alert column 740) may trigger an alert email. Email high limit 775 may include a high threshold value for which data (e.g., data in the column identified in alert column 740) may trigger n alert email. Email group 780 may include one or more email address to which an email alert may be sent (e.g., when a monitor value in a column from tables 440 falls within an email alert threshold indicated by email low limit 770 or email high limit 775). In some instances, email group 780 may include other contact formats, such as phone numbers for text messages, etc. In one implementation, values in email low limit 770 or email high limit 775 may correspond to a set of “Yellow” or “Red” threshold values for a particular chart 605.

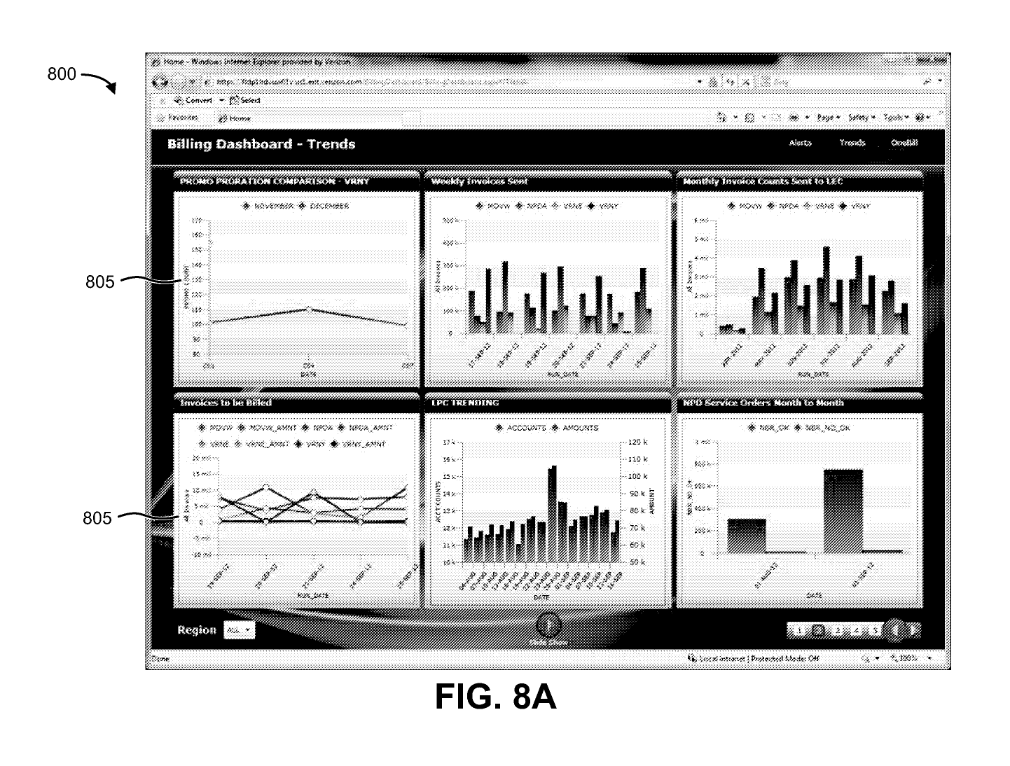

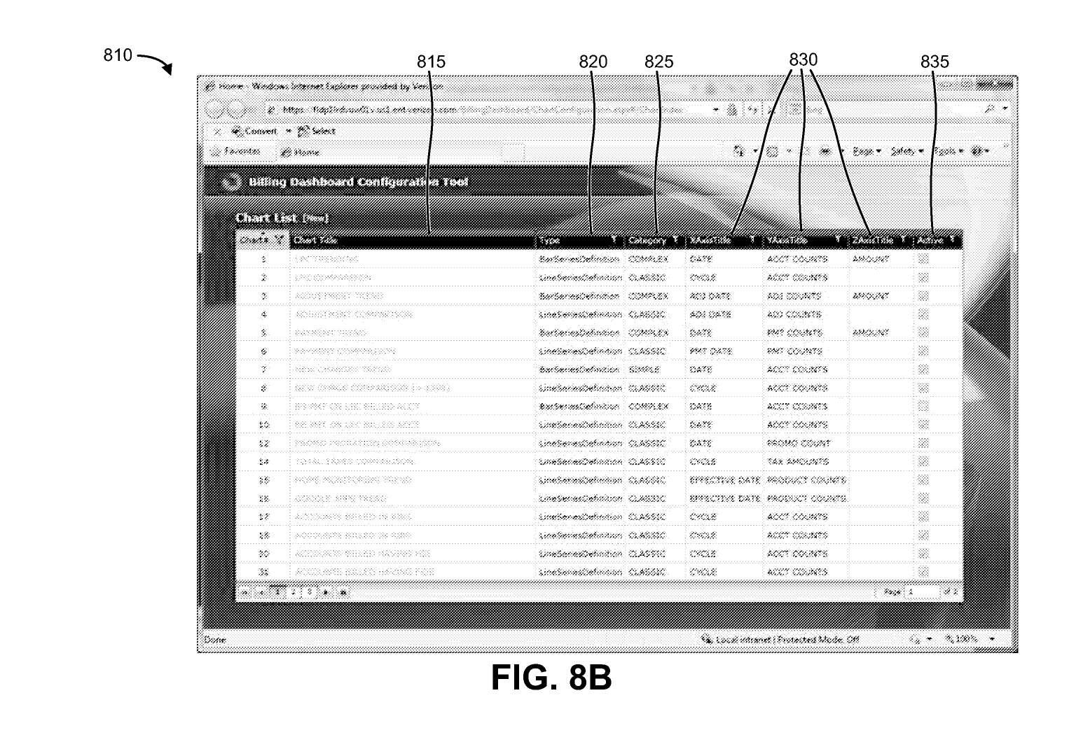

FIG. 8A provides a sample screen presentation for a billing trend dashboard 800. As shown in FIG. 8A, billing trend dashboard 800 may be included within a web browser window. Billing trend dashboard 800 may present trends for multiple different systems that may be configured, for example, as charts 805 in a single screen view. Charts 805 may be selectively presented to show particular regional metrics or collective regional (national) metrics. Thus, billing trend dashboard 800 may showcase all metrics available for a selected region, including alerts which have been configured for some of the metrics. Billing trend dashboard 800 may be configured so that no new coding is required to roll out a new report on to billing trend dashboard 800. If the data to be trending is available in analyzer database 400, then a new metric can be rolled into billing trend dashboard 800 simply by configuring parameters in via a configuration GUI.

FIG. 8B provides a sample dashboard configuration tool 810 that may permit configuration of billing trend dashboard 800. Dashboard configuration tool 810 may provide functionality to prioritize or change the order of metrics trends (e.g., charts 805) displayed on the web interface by simply changing a configuration parameter. Multiple parameters may be made available to change, for a particular trend, by manipulating options on dashboard configuration tool 810.

Dashboard configuration tool 810 may provide functionality to create new or modify existing charts (e.g., charts 805). All options to configure a chart can be made available in dashboard configuration tool 810, including a chart title field 815, a chart type field 820, a category field 825, axis labeling fields 830, and a status field 835. Other configuration options may be accessed via a detailed chart configuration GUI (e.g., detailed chart configuration GUI 820, described below). Once a chart is configured in dashboard configuration tool 810, changes can be immediately reflected on billing trend dashboard 800 without any additional steps for deployment. Any chart 805 may be activated/deactivated using dashboard configuration tool 810 and also a priority order for displaying each chart 805 could be changed for display on billing trend dashboard 800.

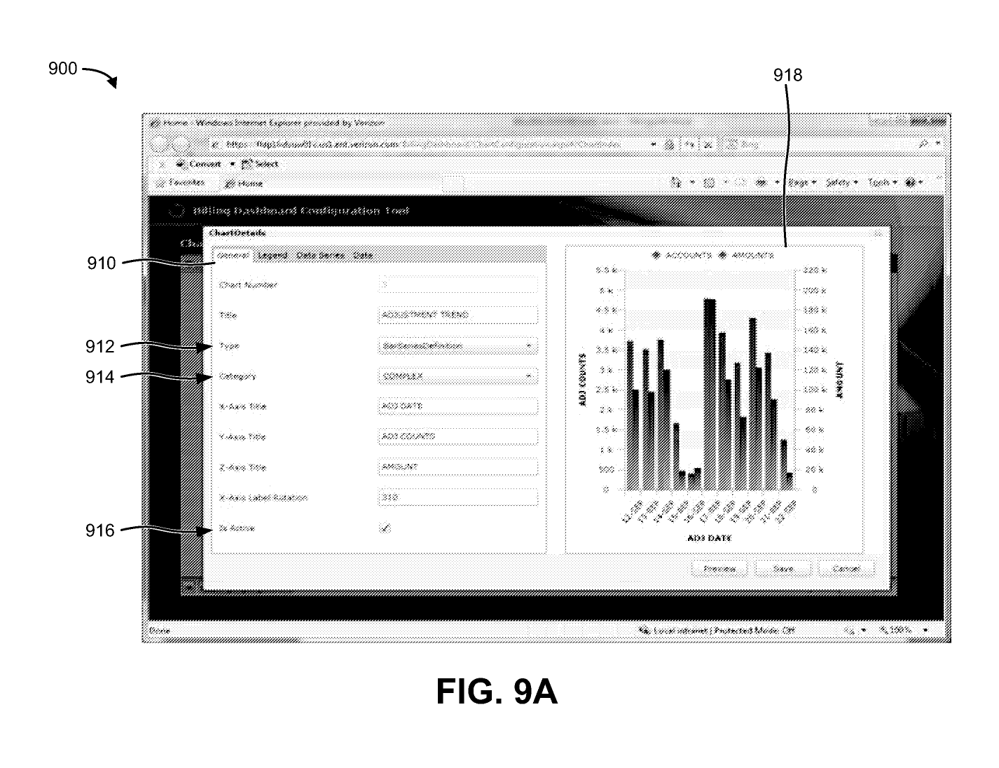

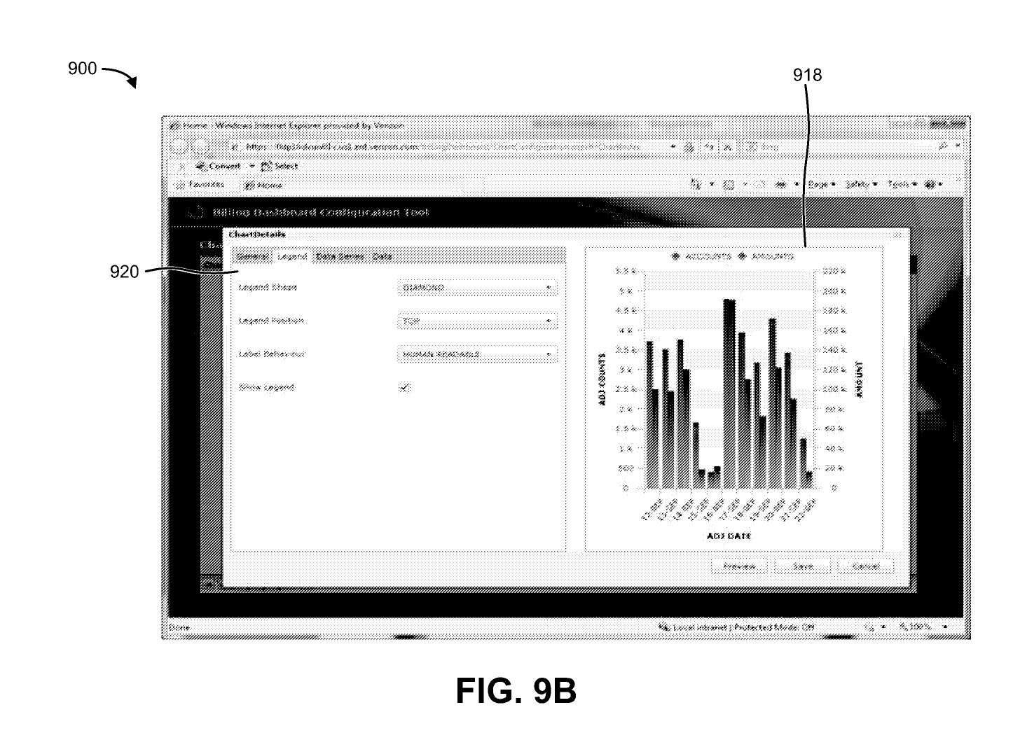

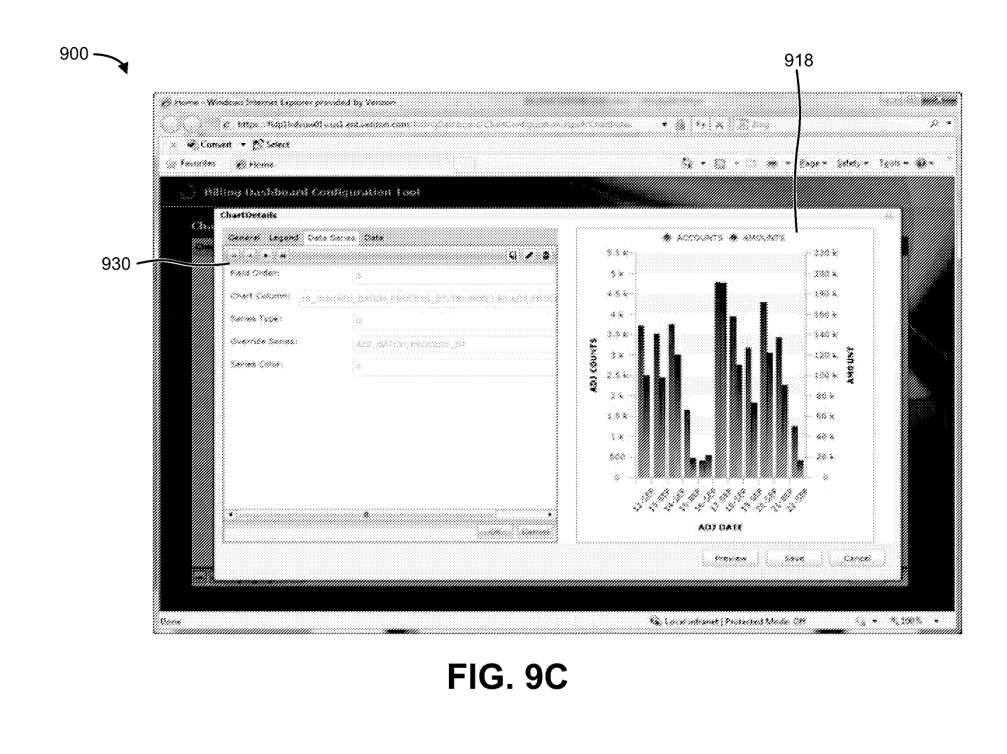

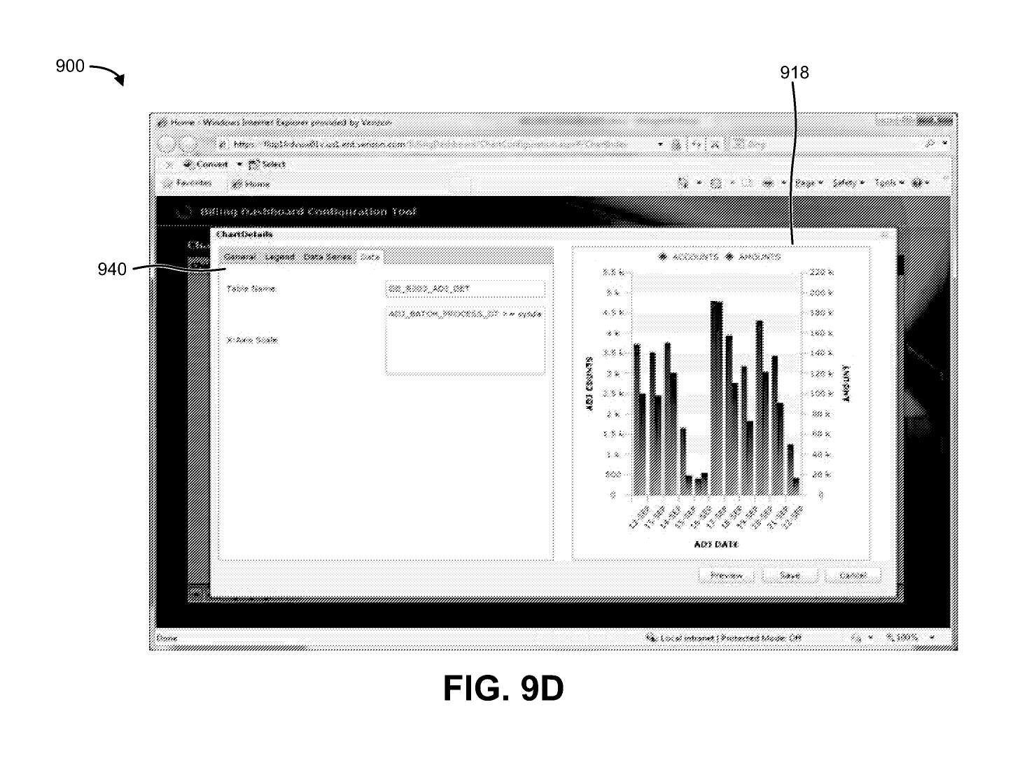

FIGS. 9A-9D provide a sample detailed chart configuration GUI 900 for dashboard configuration tool 810. A user's selection of a particular chart from dashboard configuration tool 810 may cause detailed chart configuration GUI 900 to be presented. Detailed chart configuration GUI 900 may include a general tab 910 (FIG. 9A), a legend tab 920 (FIG. 9B), a data service tab 930 (FIG. 9C), and a data tab 940 (FIG. 9D). Other tabs or combinations of information may be used.

Referring to FIG. 9A, general tab 910 provides options to configure a chart title, a type, a category, and label positions, and active status for a particular chart 805. For example, a type input field 912 may include a selection mechanism, such as a radio button, a checkbox, a dropdown menu, etc. to allow a user of detailed chart configuration GUI 900 to select a particular type of chart for chart 805. Types of charts may include, for example, area charts, bar charts, line graphs, bubble charts, etc.

A category input field 914 may include a selection mechanism to allow a user of detailed chart configuration GUI 900 to select a particular category of chart for chart 805. Categories for category input field 914 may include, for example, simple, classic, or complex. A “simple” chart category may be used to chart trending of only one variable. For example, if a number of particular event counts are being tracked for cycles billed, a simple chart category could be used (e.g., “Promo Proration Comparison—VRNY” of FIG. 8A). A “classic” chart category may be used to chart trending of more than one variable. For example, if multiple of events are being tracked each day of the month comparing the past two months trending, a classic chart category could be used (e.g., “Invoices to be build” of FIG. 8A). A “complex” chart category may be used to chart trending with three different axes. For example, if events are being tracked by both the number of different accounts and dollar amounts charged for a billing cycle, a complex chart category could be used (e.g., “LPC Trending” of FIG. 8A).

A status input field 916 may include a selection mechanism to allow a user of detailed chart configuration GUI 900 to selective toggle a particular chart as active (e.g., presented on billing trend dashboard 800) or inactive (e.g., not presented on billing trend dashboard 800). Detailed chart configuration GUI 900 may also provide a preview pane window 918. Any changes to the information in general tab 905 can be previewed on preview pane window 918 to confirm the desired effect.

Referring to FIG. 9B, legend tab 920 may include configuration options related to legend position and display options functionality for a particular chart 805. Configuration options may include, for example, shapes of legend symbols, legend position, readability options, and toggling on/off the legend. Effects of changes to options in legend tab 920 may be presented in preview pane window 918.

Referring to FIG. 9C, data service tab 930 may include configuration options related to data to be fetched (e.g., from dashboard report tables 440). For example, data services tab 930 may provide selection mechanisms to identify data series for use in a particular chart 805. Referring to FIG. 9D, data tab 940 may include configuration options to identify a table where chart data resides and define filter conditions to retrieve the range of data. Effects of changes to options in data service tab 930 or data tab 940 may be presented in preview pane window 918.

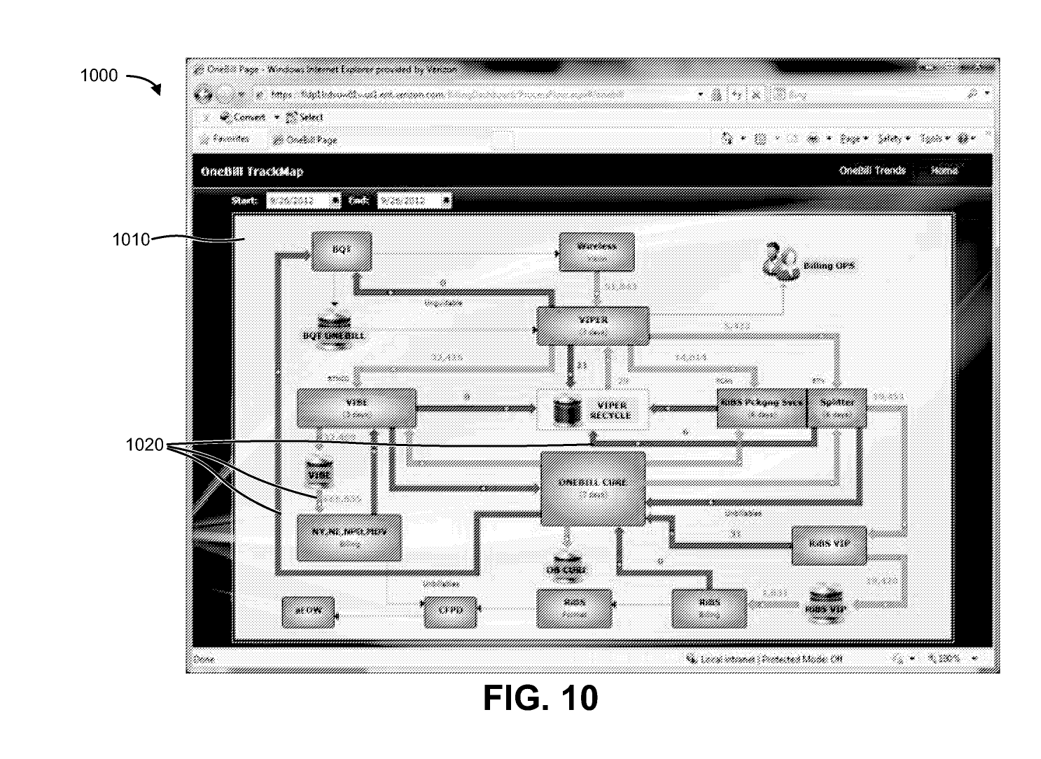

FIG. 10 provides a sample screen presentation for a consolidated billing system dashboard 1000. As shown in FIG. 10, consolidated billing system dashboard 1000 may be included within a web browser window. Generally, consolidated billing provides a single bill to customers of multiple systems (e.g., television systems, internet services systems, telephone systems, wireless communications systems, etc.) from a single service provider (e.g., service provider network 110). Consolidated billing system dashboard 1000 may provide a tracking map 1010 to track billing data touch points sent by one system flowing through another billing system. For example, tracking map 1010 may track processing of more recent system bills (e.g., for wireless communications) through a legacy billing system (e.g., a telephone system).

Consolidated billing system dashboard 1000 may track all charge records processed by various systems and keep track of all successes and fallouts in processing. Tracking map 1010 may provide a GUI that presents real-time status of billing data process through each processing point 1020 (e.g., a collection point, a review point, a combination point, etc.) of a consolidated billing system. In one implementation, process flow segments 1030 between processing points 1020 may be color-coded to reflect a process status. For example, green connectors may represent successful processes and red connectors may represent process fallouts. Color-coding may be based on, for example, a threshold level of fallouts configured for each process flow segment 1030. Operations personnel may monitor fallout details, based on input from the tracking map 1010, and advise involved systems to make necessary corrections to flow down the corrected records to downstream applications for further processing. In one implementation, each process flow segment 1030 may include a selectable link that may be selected from tracking map 1010.

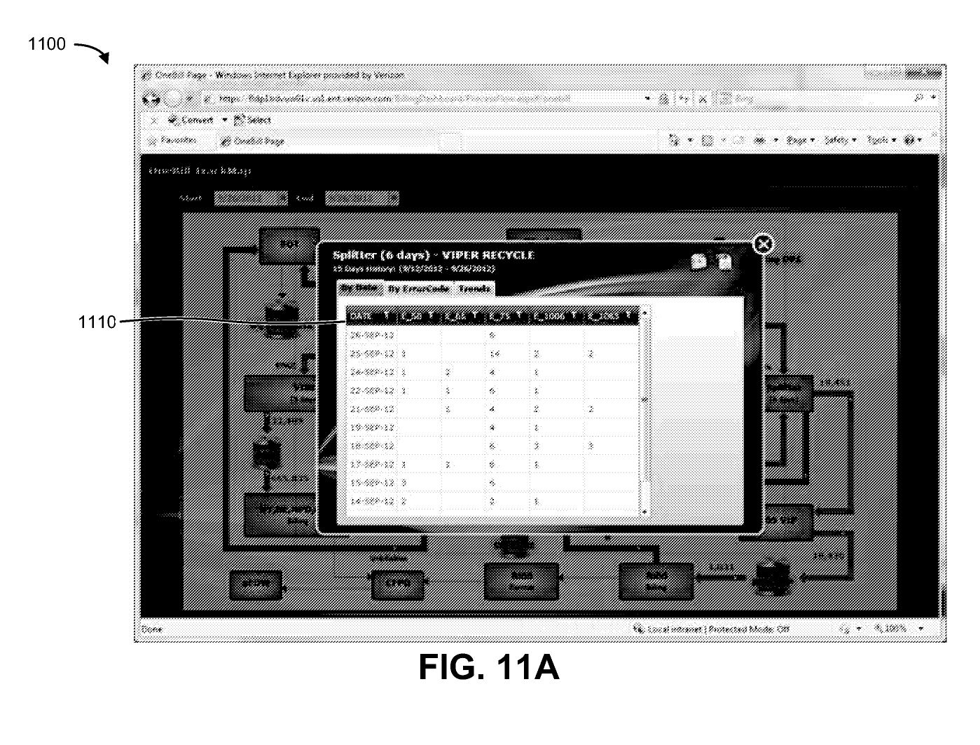

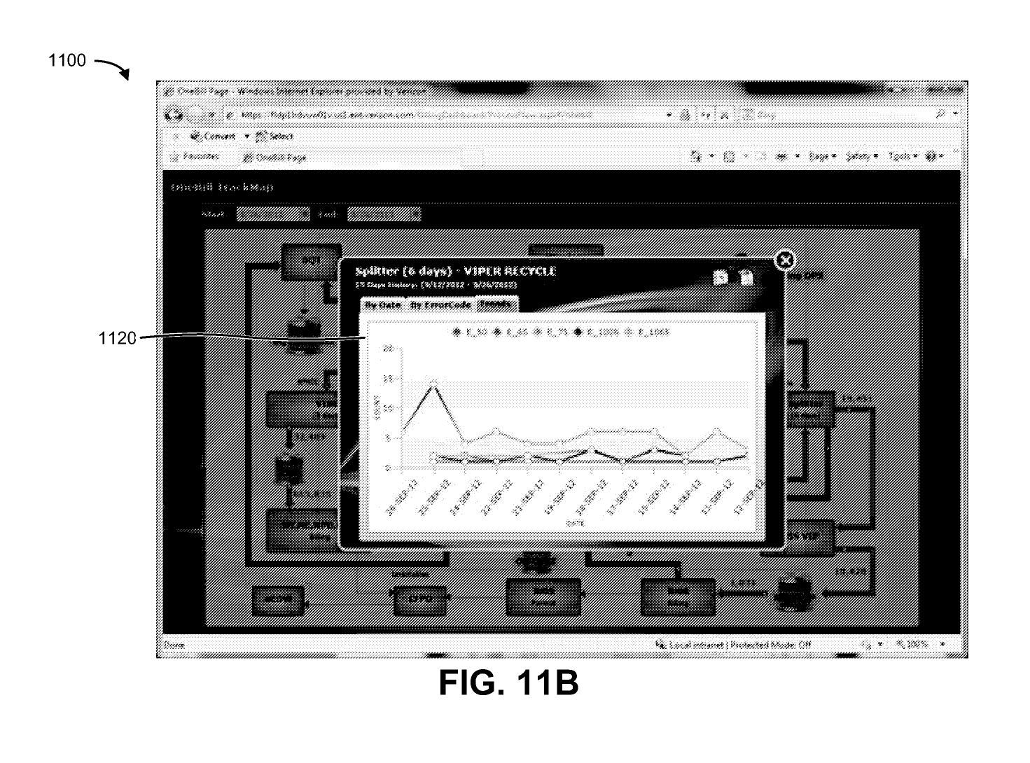

FIGS. 11A-11B provide a sample process detail GUI 1100 for tracking map 1010. Selection by a user of a particular process flow segment 1030 (e.g., a green or red connecting line) from tracking map 1010 may cause process detail GUI 1100 to be presented. Process detail GUI 1100 may include a by-date tab 1110 (FIG. 11A), a by-error-code tab, and a trends tab 1120 (FIG. 11B). Other tabs or combinations of information may be used.

Referring to FIG. 11A, by-date tab 1110 may include a listing, sorted by date, of error codes within a previous time period (e.g., 15 days) for a selected process flow. Similarly, the by-error-code tab may include a listing, sorted by error code of reported errors within the previous time period. Process detail GUI 1100 may extract the dates/error codes from, for example, dashboard report tables 440. In one implementation, process detail GUI 1100 may also provide functionality to export data from by-date tab 1110 or the by-error-code tab to a spreadsheet or document file. Referring to FIG. 11B, trends tab 1120 may include a trend chart of the period (e.g., 15 days) for each error code for the selected process flow.

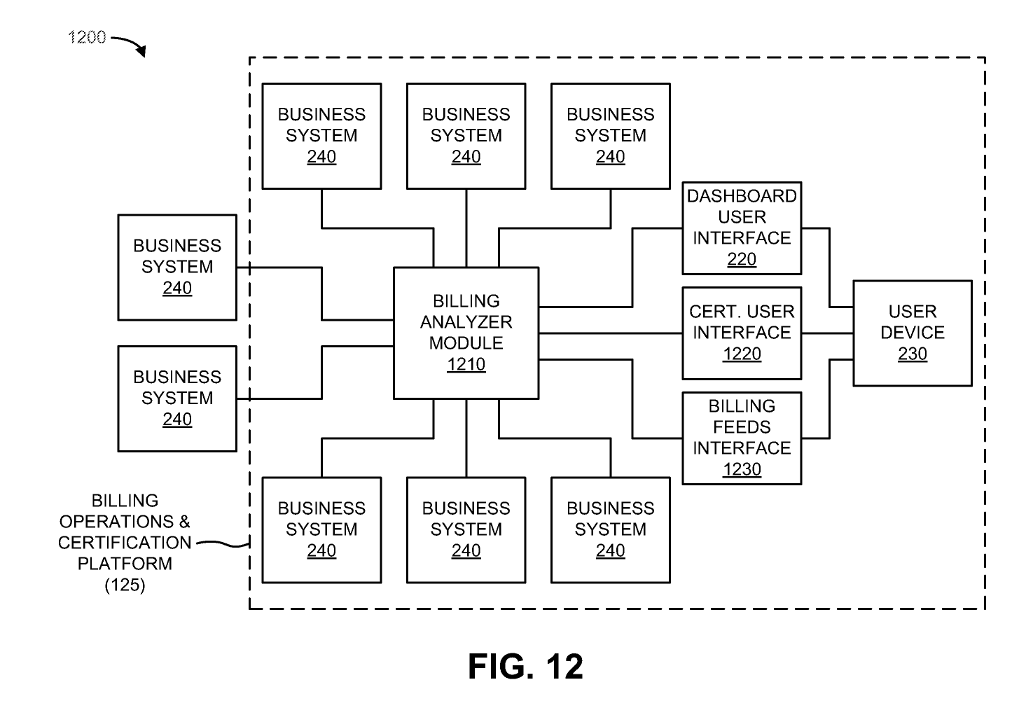

FIG. 12 is a diagram that illustrates an exemplary portion 1200 of service provider network 110, according to another implementation described herein. As shown in FIG. 12, service provider network 110 may include billing operations and certification platform 125 that includes dashboard user interface module 220, user device 230, business systems 240, a billing analyzer module 1210, a certification user interface module 1220, and a billing feeds interface module 1230. Dashboard user interface module 220, user device 230, and business systems 240 may include features described above in connection with, for example, FIGS. 2-11. Generally, the configuration of network portion 1200 may provide a separate user interface for billing certifications that may be used in addition to (or exclusive from) the dashboard features described above in connection with FIGS. 1-11.

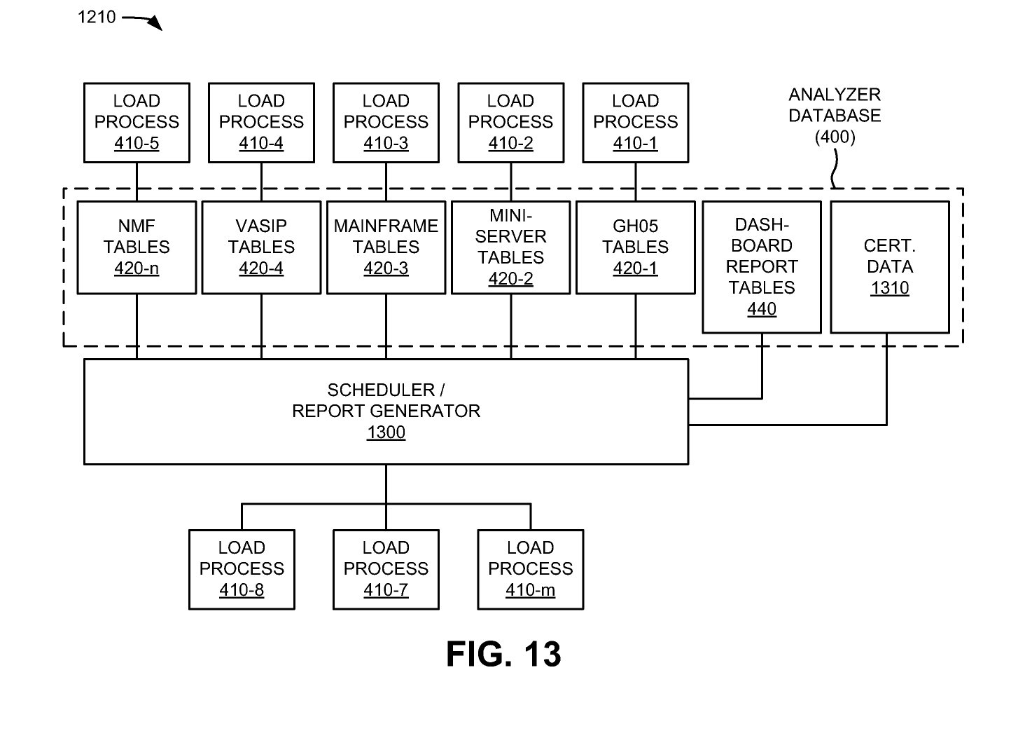

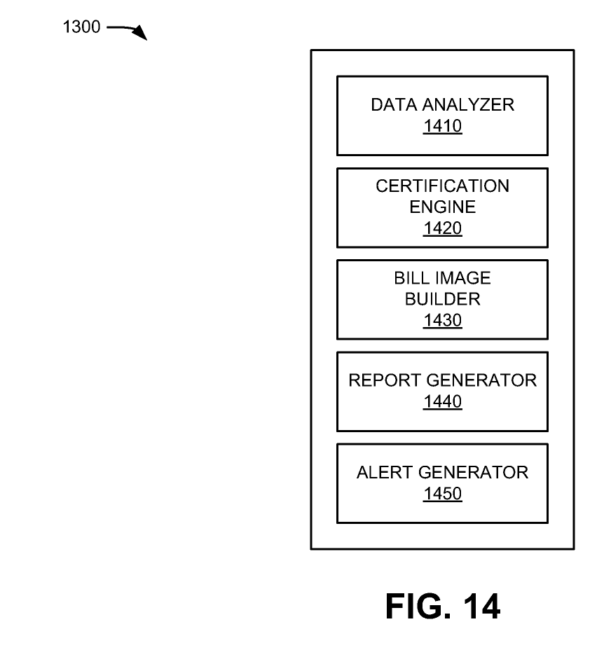

Billing analyzer module 1210 may include one or more server devices, or other types of computation or communication devices, that gather, process, search, and/or provide information in a manner described herein. For example, billing analyzer module 1210 may provide functionality to identify potential certification issues and to further research certification issues by providing bill details and analysis in helping to find the root cause. Billing analyzer module 1210 may process certification data and populate summary information in respective tables which can be input for certification user interface module 1220. Billing analyzer module 1210 is described further below in connection with FIGS. 13 and 14.

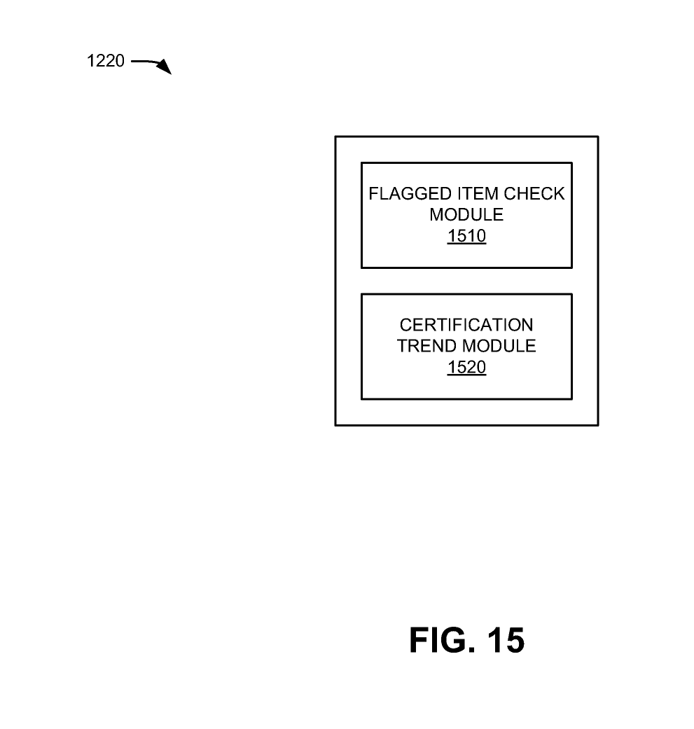

Certification user interface module 1220 may include combination of hardware and software to present trends, alerts, and failed certification checks related to, for example, internal billing certifications for service provider network 110. In other implementations, some or all of certification user interface module 1220 may be combined with other components of network portion 1200. For example, one implementation, dashboard user interface module 220 and certification user interface module 1220 may be included as a single component. Certification user interface module 1220 is described further below in connection with FIGS. 15-17.

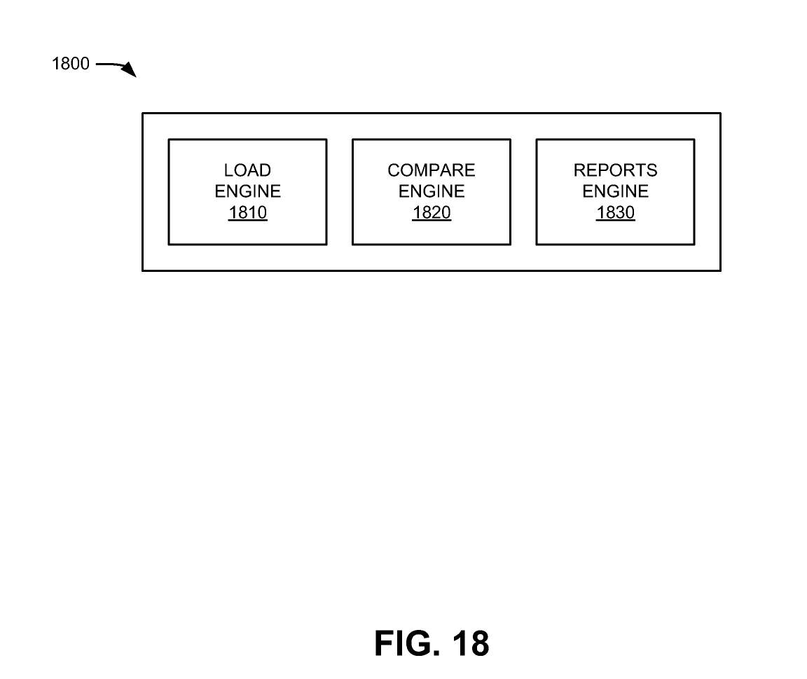

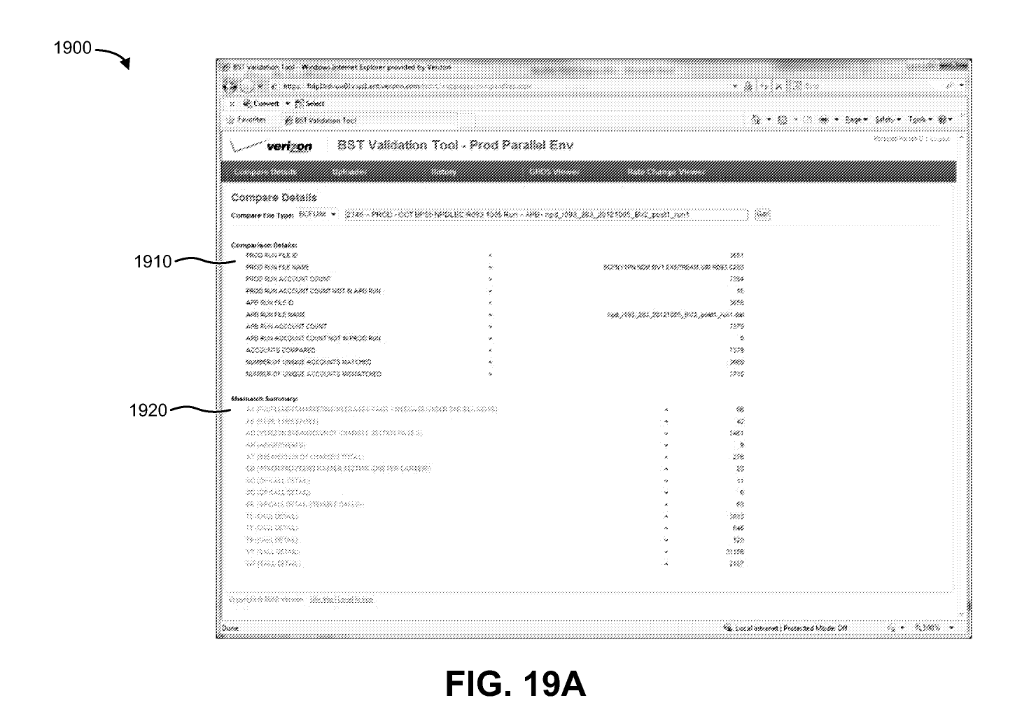

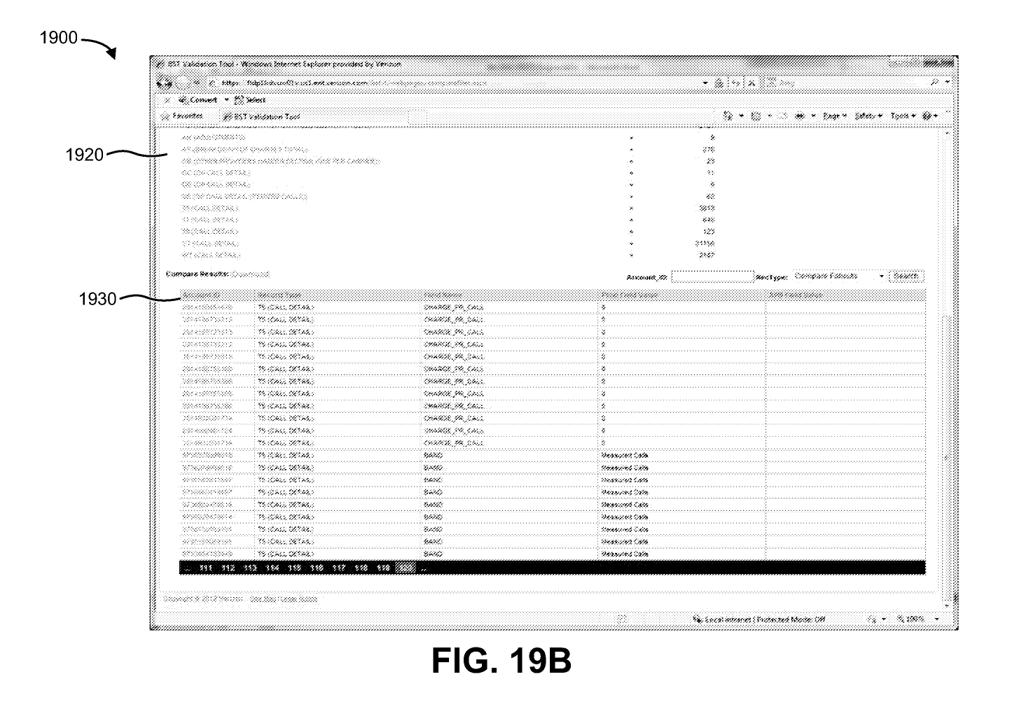

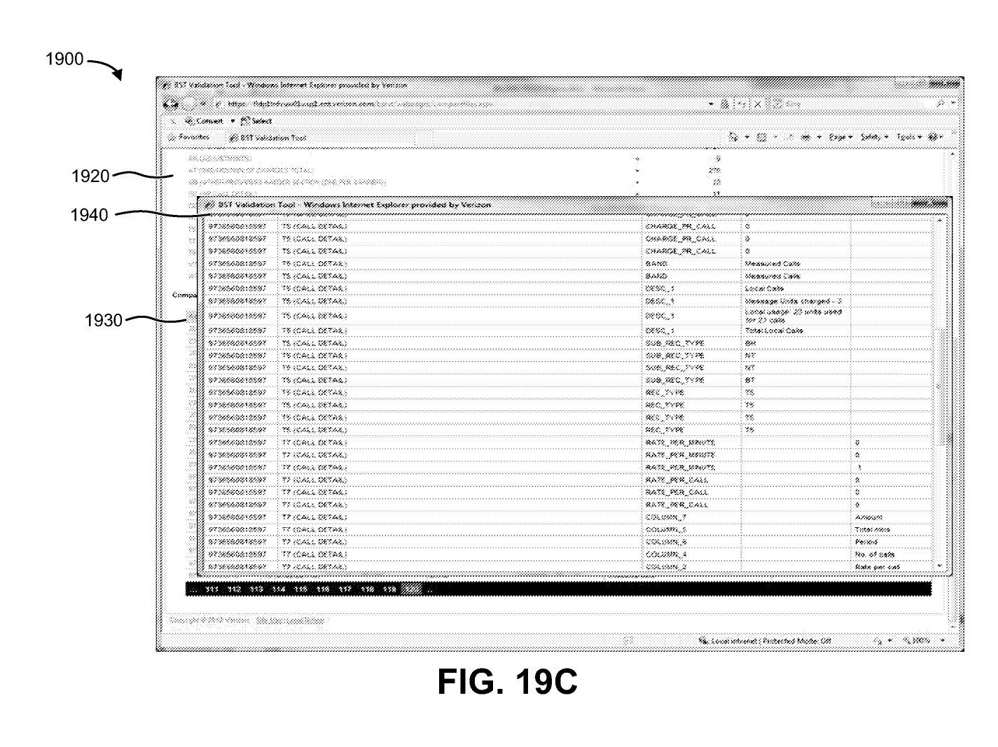

Billing feeds interface module 1230 may include combination of hardware and software to present validation information and summary data related to, for example, load processes 410 used to supply data to analyzer data base 400 and/or other tables for service provider network 110. In other implementations, some or all of billing feeds interface module 1230 may be combined with other components of network portion 1200. For example, one implementation, billing feeds interface module 1230 may be combined with one or more of dashboard user interface module 220 and certification user interface module 1220. Billing feeds interface module 1230 is described further below in connection with, for example, FIGS. 18-19C.

FIG. 13 is a block diagram of exemplary functional components of billing analyzer module 1210. As shown, billing analyzer module 1210 may include analyzer database 400, which is fed by load processes 410, and a scheduler/report generator 1300. Analyzer database 400 may include tables 420, dashboard report tables 440, and certification data 1310. Depending on the implementation, billing analyzer module 1210 may include additional, fewer, or different functional components than those illustrated in FIG. 1210. Load processes 410, tables 420, and dashboard report tables 440 may include features described above in connection with, for example, FIGS. 4-11.

In one implementation, scheduler/report generator 1300 may include features of scheduler/report generator 430 described above in connection with FIGS. 4-11. Additionally, or alternatively, scheduler/report generator 1300 may receive billing certification data from one or more of load processes 410 and may store the received billing certification data as certification data 1310 within analyzer database 400. Additional features of scheduler/report generator 1300 are described further in connection with FIG. 14.

Certification data 1310 may include certification data (e.g., fed from one or more of load processes 410) and configuration settings which may be received from certification user interface 1210. Configuration settings may include, for example, alert settings, trend configurations, alert settings, etc.

FIG. 14 is a block diagram of exemplary functional components of scheduler/report generator 1300. As shown, scheduler/report generator 1300 may include a data analyzer 1410, a certification engine 1420, a bill image builder 1430, a report generator 1440, and an alert generator 1450. Depending on the implementation, scheduler/report generator 1300 may include additional, fewer, or different functional components than those illustrated in FIG. 14.

Data analyzer 1410 may receive input files from, for example, one of business systems 240 and check data formats for the input files and split out data into particular fields for certification database 1310. Data analyzer 1410 may certify various section of the bill file and provide all metrics to be presented on billing certification GUI.

Certification engine 1420 may include rules and/or tables for analyzing issues with billing data (e.g., billing data stored in certification database 1320). Certification engine 1420 may process and synthesize data from certification data 1310 based on the stored rules and/or tables to identify issues with billing data.

Bill image builder 1430 may construct images of one or more bills for presentation to a user. Bill image builder 1430 may, for example, retrieve billing data (e.g., from one or more of tables 420 and/or certification database 1310 to create an image of a prospective (e.g., not yet issued) bill for a particular account. The image of the prospective bill may replicate presentation and formatting of an actual bill to simplify visual comparisons with previously issued bills. In one implementation, bill image builder 1430 may retrieve data from previous bills to present a comparison of billing images for a particular account. For example, if a certification check (e.g., by certification engine 1410) identifies a problem with a particular bill, a user may be prompted to view the current and past bills for comparison. Bill image builder 1430 may compile billing data for the particular account and generate an image of, for example, bills of the past three months for that particular account.

Report generator 1440 may generate certification reports for a particular month and/or billing cycle. Report generator 1440 may, for example, receive user input to identify a particular region (e.g., a state, locality, etc.) and period (e.g., month, billing cycle, etc.). Report generator 1440 may retrieve certification data and configuration settings from certification data 1310 and populate the relevant data in a report template for presentation to a user.

Alert generator 1450 may receive alert indications (e.g., from data analyzer 1420) and may generate/send an alert (e.g., email, SMS message, etc.) to a particular user or group of users. In another implementation, alert generator may receive alert settings, monitor particular data based on the alert settings, and generate alerts when the monitored data matches the alert settings. For example, alert generator 1450 may employ a table of alert settings similar to table structure 710 described above in connection with FIG. 7.

FIG. 15 is a block diagram of exemplary functional components of certification user interface module 1220. As shown, certification user interface module 1220 may include a flagged item check module 1510 and a certification trend module 1520. Depending on the implementation, certification user interface module 1220 may include additional, fewer, or different functional components than those illustrated in FIG. 15. For example, in some implementations, certification user interface module 1220 may include other functional components, such as components similar to presentation module 510 and a configuration mode 520 of FIG. 5.

Flagged item check module 1510 may provide a user interface to present items that may be potential certification issues (e.g., as identified by certification engine 1420). Flagged item check module 1510, may for example, present a report of issues for particular metrics. Certification trend module 1520 may provide a user interface to present selected trends to a user of user device 230 and to allow users to adjust presentation of particular trends.

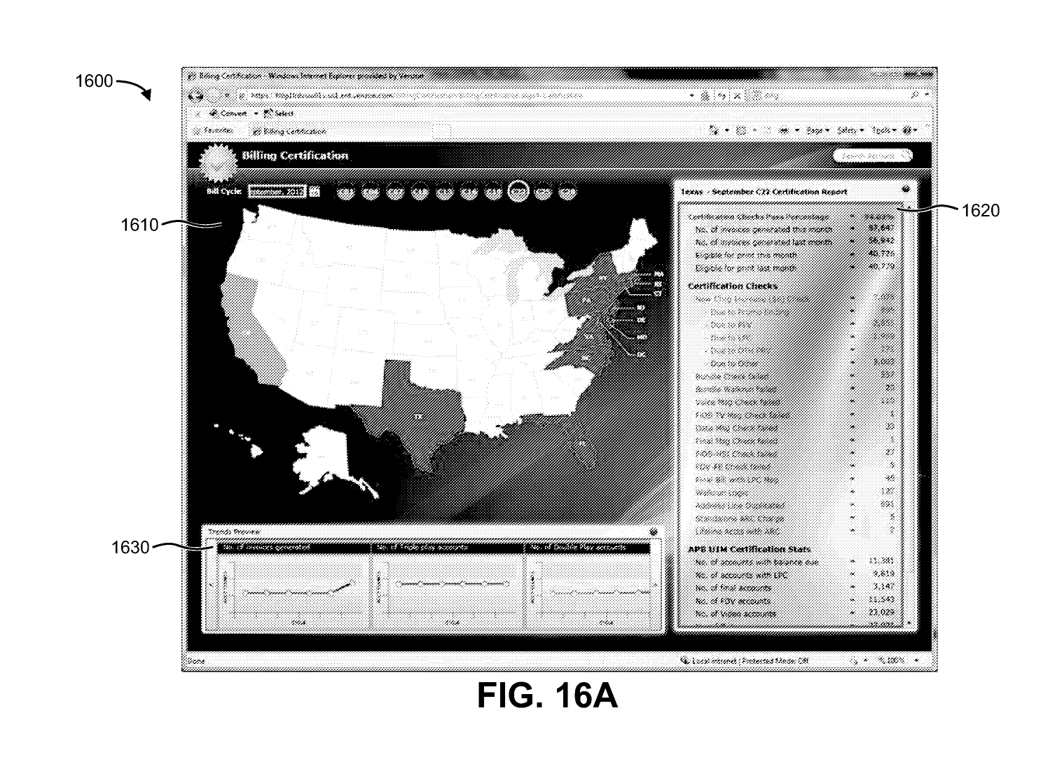

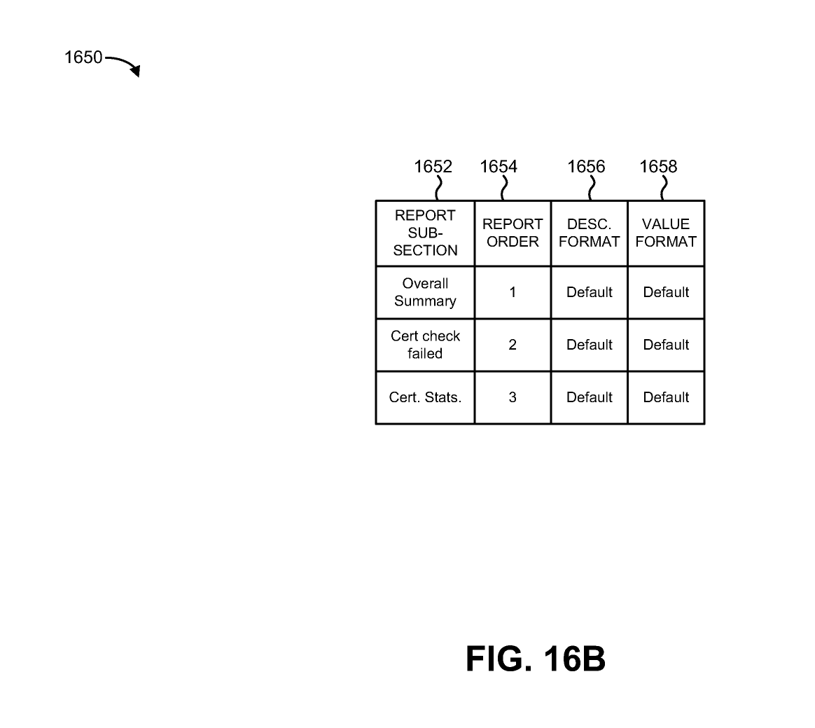

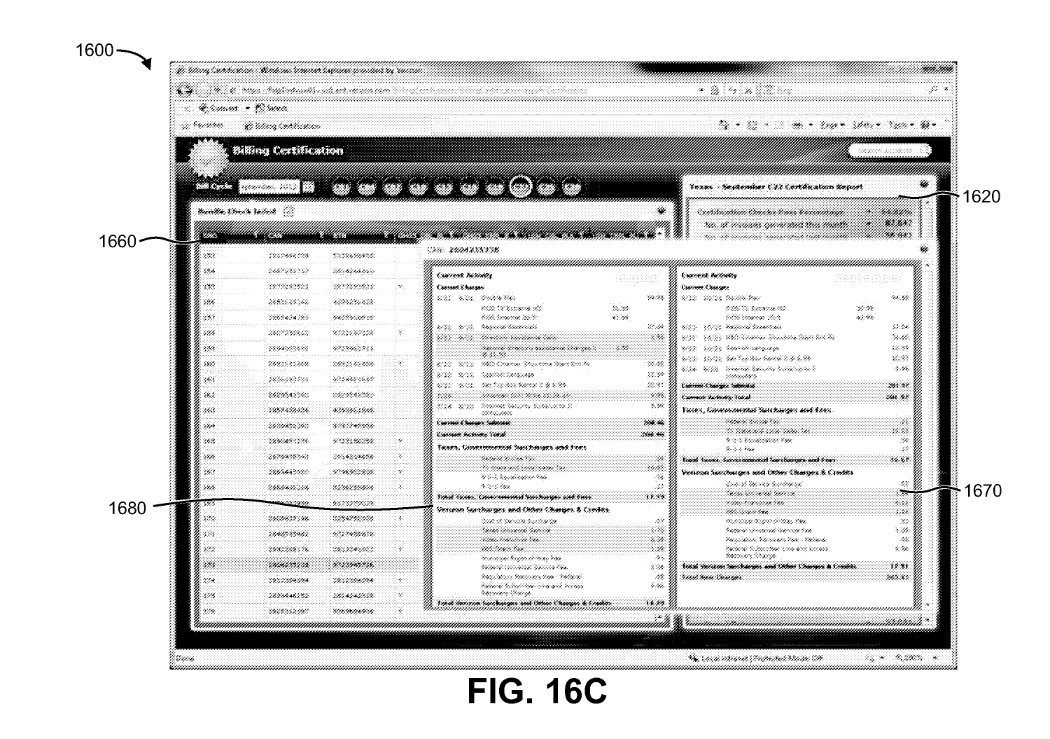

FIGS. 16A-16C provides a sample screen presentation for a billing certification dashboard 1600. Billing certification dashboard 1600 may be presented to user device 230 via certification user interface module 1220 that may simultaneously employ flagged item check module 1510 and certification trend module 1520. As shown in FIG. 16, billing certification dashboard 1600 may be presented within a web browser window. Billing certification dashboard 1600 may present certification details available for a particular month and/or billing cycle selected by a user. For example, billing certification dashboard 1600 may include a map 1610 to graphically represent regions available for selection. Certification status of particular regions (e.g., a state, county, etc.) in map 1610 may be color coded. For example, if a billing certification processing has been completed for a particular region, then the color for the region could be green; otherwise the region could remain in gray.

Map 1610 may be configured to enable a user to select a particular region for addition billing certification details. For example, once a user selects a state, flagged item check module 1510 may present a certification report 1620 with details corresponding to that state for the particular month and/or billing cycle. Certification report 1620 may be shown, for example, adjacent to map 1610 (as shown in FIG. 16A) or as a pop-up window. Similarly, when a particular state is selected, certification trend module 1520 may present a trends preview window 1630. Trends preview window 1630 may be displayed, for example, below map 1610 (as shown in FIG. 16A) or as a pop-up window.

As shown in FIG. 16A, certification report 1620 may present a certification checks pass percentage, for all accounts certified for a cycle, may be displayed, along with all certification checks that were flagged (e.g., by certification engine 1420). In one implementation, items in report 1620 may be color coded. For example, certification checks identified in blue may indicate that potential issues exist which need to be investigated and those items are counted against a pass percentage for a corresponding category. Conversely, checks identified in green may be provided for information purposes only for tracking a particular scenario, and these items would not impact the pass percentage.

Content of certification report 1620 may be configured (e.g., by report generator 1440) within a separate certification report configuration table 1650. As shown in FIG. 16B, certification report configuration table 1650 may include report sub-section field 1652 that may identify a particular subsection within certification report 1620. Consistent with the embodiment of FIG. 16A, sub-sections in certification report 1620 may include, for example, an overall summary section, a certification check failed section, and a certification statistics section. Content of certification report 1620 can be extended or modified any time by changing certification report configuration table 1650. In one implementation, certification report configuration table 1650 may also include a report order field 1654 to control the listed order of each sub-section (e.g., in report sub-section field 1652). Additionally, font sizes and colors of certification report 1620 may be controlled by a description format field 1656 and a value format field 1658 in certification report configuration table 1650. In one implementation, pre-defined default settings may be available in a default configuration table.

Trends preview window 1630 may present one or more charts of metrics being tracked along with failed checks trending. For example, trends preview window 1630 may include trending of key statistics for the last six months for that cycle to help identify any potential system issues for the major key statistics of the billing system metrics. If any of the trend charts in trends preview window 1630 are selected, a bigger display with statistics may be displayed. Each of the charts in trends preview window 1630 may be controlled by a chart table and a data series table, similar to those described above in connection with FIGS. 9A-9D.

As shown in FIG. 16C, selection of any of the checks in certification report 1620 may cause certification user interface module 1220 to present the list of affected accounts 1660 to present on the same screen as certification report 1620 (e.g., to the left of the pane for certification report 1620). Any account on list 1660 may be selected to view a bill detail to analyze the metric that the bill failed against. There may be two types of bill views available in billing certification dashboard 1600, and the default selection of either type may be controlled by a particular field in a configuration table. For example, if a “bill compare” field set to ‘Y’ in the configuration table for a particular metric, a bill comparison view may be displayed; otherwise a single bill view may be shown. The rendering of the bill format may be generated from raw billing data (e.g., from one or more of tables 420) and is configured to mimic exactly the bill image that would be generated by an image generator system.

The single bill view (not shown) may present only the prospective (e.g., not yet issued) current month bill. However, for some metrics it could be easier to research a current and a previous bill side by side. FIG. 16C provides a view of the bill comparison view with an image of a prospective current bill 1670 and a previous month bill 1680 for the same account. In the bill comparison view, certification user interface module 1220 may highlight the differences in charge details between the months (e.g., between bills 1670 and 1680) to expedite a user's researching of the issue reported.

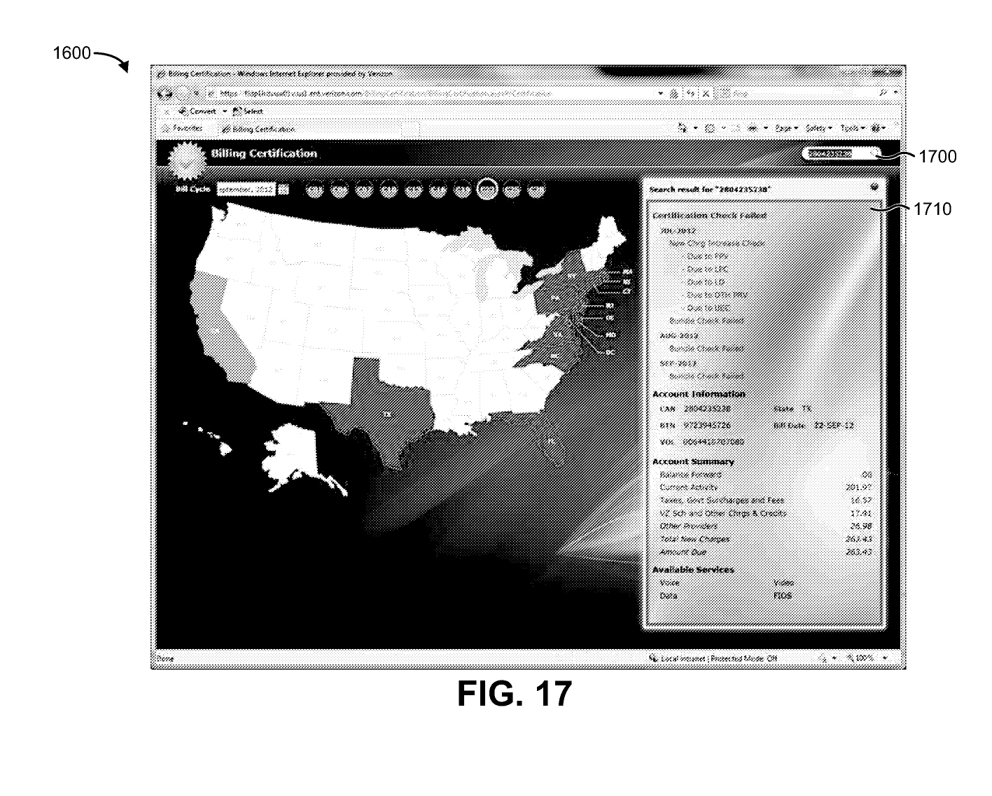

FIG. 17 provides a sample screen presentation of a search interface for billing certification dashboard 1600. As shown in FIG. 17, billing certification dashboard 1600 may include a search box 1700 for searching account details/history in, for example, certification data 1310. Results from a search may be presented in a search results pane 1710. As shown in FIG. 17, for a search for a particular account, a search could yield results in search results pane 1710 for: certification check failed, account information, account summary, and available services associated with the particular account. The data fetched would show all the checks it failed for the last three recent bill cycle runs if any exist for the account. If the “Certification Check Failed” link on search results pane 1710 is selected by a user, then a bill image comparison (e.g., similar to the bill comparison view of FIG. 16C may be presented. Content of search results pane 1710 may be controlled by a configuration in table that may also control font size, color, order, and hyperlink functionality.

FIG. 18 is a block diagram of a billing feeds processor 1800 according to an implementation described herein. One or more components of billing feeds processor 1800 may be included, for example, within billing feeds interface module 1230 (FIG. 12). Billing feeds processor 1800 may include a load engine 1810, a compare engine 1820, and a reports engine 1830. Components of billing feeds processor 1800 may correspond to one or more components described above. For example, in one implementation, billing feeds processor 1800 may be included within billing analyzer 210.

Generally, billing feeds processor 1800 may process mainframe billing feeds on open systems (e.g., Unix, Linux, etc.) by parsing the feed using copybooks and loading the data into database tables (e.g., tables 420). Billing feeds processor 1800 may have functionality to decode mainframe compressed fields by reading binary data and converting them to numeric data. Billing feeds processor 1800 may process various billing feeds with different data standards by simply providing configuration options to load engine 1810. Load engine 1810 may extract data from billing feed files and load the data into different tables. Once the data of billing feeds are loaded into tables, comparison between various loads can be performed using compare engine 1820. The data differences identified by compare engine 1820 may be included in a report (e.g., from reports engine 1830) and displayed on a web page to be analyzed by users.

More particularly, load engine 1810 may identify a feed file identifier (ID) and file type. For example, load engine 1810 may read a file ID for the execution run from a sequence table that includes multiple feed files. Load engine 1810 may read a billing feeds file passed as arguments and may parse the fields in the billing feeds file by reading copybook layouts defined in a database table. For example, load engine 1810 may identify a trailer record in the file to identify a line count and confirm the line count in the trail record matches an actual line count of the feed file. Load engine 1810 may also match records in the file to the copybook layout and store the records in a data table that associates each record with a file ID and sequence. After parsing the data for respective record types, load engine 1810 may load the data by record type into respective tables. Load engine 1810 may then generate a control report detailing the records processed and any failures in processing.

Compare engine 1820 may compare all fields by record type between two billing feeds in a database (e.g., as provided by load engine 1810) and loads all the differences between the runs in a designated table (e.g., a compare_fallouts table). Compare engine 1820 may perform a straight comparison or can translate/transform data of a run before comparison or can have rules where multiple records in one run are now translated to one record in other run being compared. For example, for a particular account, compare engine 1820 may compare the line count of all record types on the account, compare the record type counts on the account, and compare the fields by record type. Compare engine 1820 may store any discrepancies in the compare_fallouts table. Compare engine 1820 may also generate detail and summary control reports for each execution run. For example, compare engine 1820 may report the file ID, account ID and bill line sequence number in both the compared files, along with any field discrepancies that were discovered.

Reports engine 1830 may provide an interface to presents all the details from the compare process (performed by compare engine 1820) on a webpage (accessible by user device 230) for analyzing/researching the differences between runs compared. FIG. 19A-19C provide exemplary user interfaces that may be generated by reports engine 1830. As shown in FIG. 19A, a feed comparison webpage 1900 may include a comparison details section 1910 to display the total number of accounts in PRE and POST feeds and a mismatch summary section 1920 to display all difference counts by record type.

Each record type in mismatch summary section 1920 may include a link to a detailed list. For example, if any of the mismatch summary record types in mismatch summary section 1920 are selected then a detail list of all accounts for which differences exist for the record type is displayed below the summary section. As shown in FIG. 19B, selection of record type TS (Call Details) may cause reports engine 1830 to provide a list of accounts 1930 associated with that particular mismatched record (e.g., presented below mismatch summary section 1920).

Each listed account in list of accounts 1930 may include a link to a detailed list of fields for that particular account. As shown in FIG. 19C, if any account is selected from list of accounts 1930, a pop-up window 1940 may display all fields mismatched on the selected account.

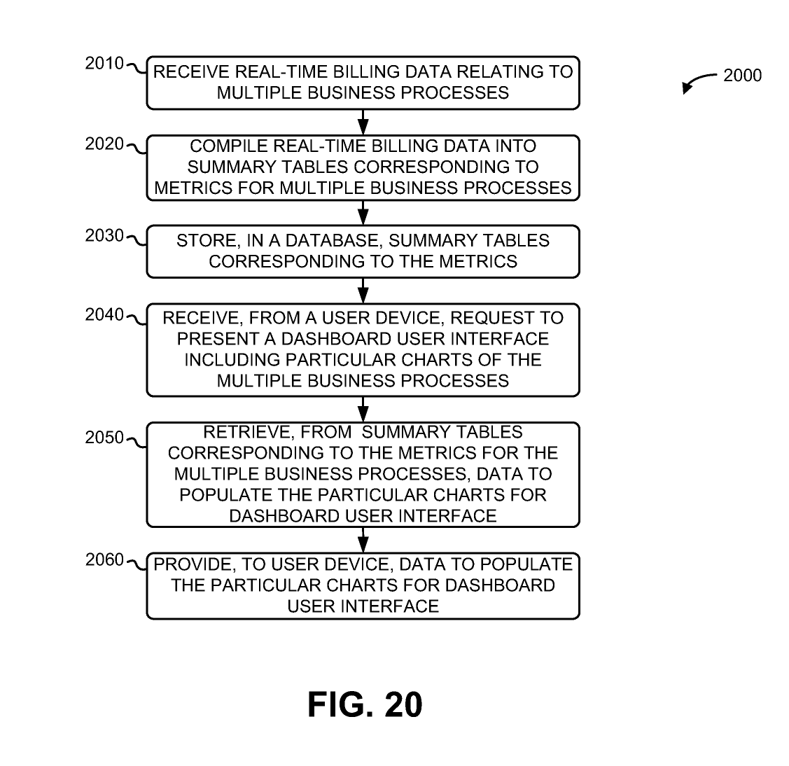

FIG. 20 is a flowchart of an exemplary process 2000 for providing a billing system user interface tool, according to an implementation described herein. In one implementation, process 2000 may be performed by one or more components of billing operations and certification platform 125, such as one or more processing units 320. In another implementation, one or more blocks of process 2000 may be performed by one or more other devices or a group of devices including or excluding components of billing operations and certification platform 125.

Process 2000 may include receiving real-time billing data relating to multiple business processes (block 2010), compiling the real-time billing data into summary tables corresponding to metrics for the multiple business processes (block 2020), and storing, in a database, the summary tables corresponding to the metrics for the multiple business processes (block 2030). For example, one or more of business systems 240 may generate real-time billing data. Billing analyzer module 210/1210 may receive the data from business systems 240, synthesize the data, and generate metrics that are relevant to business operations. Billing analyzer module 210/1210 may process the data and populate summary information in respective tables which can be used as input for one or more of dashboard user interface module 220, certification user interface module 1120, or billing feeds interface module 1230.

Process 2000 may further include receiving, from a user device, a request to present a dashboard user interface including particular charts of the multiple business processes (block 2040), retrieving, from one or more of the summary tables corresponding to the metrics for the multiple business processes, data to populate the particular charts for the dashboard user interface (block 2050), and providing, to the user device, the data to populate the particular charts for the dashboard user interface (block 2060). For example, dashboard user interface module 220 may provide user access to summary information from billing analyzer module 210. For example, dashboard user interface module 220 may showcase the trending of real-time billing metrics, as well as provide alerts of any deviation in trending from one period over another. Dashboard configuration tool 810 may provide functionality to create new or modify existing charts. Some or all of the tables in dashboard report tables 440 may be retrieved by dashboard user interface module 220 to populate a dashboard presentation for user device 230.

Systems and/or methods described herein may receive, from business processes of a consolidated billing system for multiple telecommunications services, real-time billing data relating to the business processes and may compile the real-time billing data into summary tables corresponding to metrics for the business processes. The systems and/or methods may store, in a database, the summary tables corresponding to the metrics for the business processes and may retrieve, from one or more of the summary tables corresponding to the metrics for the business processes, data to present a graphical tracking map for the consolidated billing system. The graphical tracking map may track bill processing of a billing data from a first telecommunications service through a billing system of a second telecommunications service. The systems and/or methods may provide, to the user device, the data to populate the graphical tracking map.

In this specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

While a series of blocks has been described with regard to the process 2000 illustrated in FIG. 20, the order of the blocks may be modified in other implementations. Further, non-dependent blocks may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware can be designed to implement these aspects based on the description herein.

Further, certain portions of the invention may be implemented as a “component” or “system” that performs one or more functions. These components/systems may include hardware, such as a processor, an ASIC, or a FPGA, or a combination of hardware and software.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

What is claimed is:

1. A device, comprising:
a memory to store a plurality of instructions; and
a processor configured to execute instructions in the memory to:
receive, from multiple business processes, real-time billing data relating to the multiple business processes,
compile the real-time billing data into summary tables corresponding to metrics for the multiple business processes,
store, in a database, the summary tables corresponding to the metrics for the multiple business processes,
receive, from a user device, a request to present a dashboard user interface including particular charts of the multiple business processes,
retrieve, from one or more of the summary tables corresponding to the metrics for the multiple business processes, data to populate the particular charts for the dashboard user interface, and
provide, to the user device, the data to populate the particular charts for the dashboard user interface.

2. The device of claim 1, wherein the processor is further configured to:
provide, to the user device, a configuration interface for presentation of the multiple business processes,
receive, from the user device and via the configuration interface, updated configuration settings that associate a particular chart with a particular table from the database of summary tables, and
provide, to the user device, updated data to populate the particular chars for the dashboard user interface based on the updated configuration setting.

3. The device of claim 1, wherein the processor is further configured to:
provide, to the user device, data to present a graphical tracking map for a consolidated billing system, wherein the graphical tracking map tracks bill processing of a billing data from a first system through a billing system of a second system.

4. The device of claim 3, wherein, when providing the data to present a graphical tracking map, the processor is further configured to:
provide a selectable link of a particular process flow segment, wherein the selectable link points to additional details of the particular process flow segment.

5. The device of claim 4, wherein, when providing the data to present a graphical tracking map, the processor is further configured to:
provide color-coding for the selectable link to distinguish between a successful process and a failed process.

6. The device of claim 1, wherein the summary tables corresponding to metrics for the multiple business processes include one or more tables of items that have been flagged for potential billing certification issues, and
wherein the processor is further configured to provide, to the user device, data to present a graphical interface for selecting geographical regions for a consolidated billing system, wherein the graphical interface includes links to present a summary of the potential billing certification issues for each of the geographical regions.

7. The device of claim 6, wherein the processor is further configured to:
receive a selection of one of the geographical regions, and
generate, based on the selection, a summary of the potential billing certification issues for the selected one of the geographical regions.

8. The device of claim 7, wherein the processor is further configured to:
generate, based on the selection, a trend preview including one or more charts of metrics, relevant to the potential billing certification issues, being tracked for the selected one of the geographical regions.

9. The device of claim 8, wherein the processor is further configured to:
construct an image of a prospective bill for presentation to the user, wherein the bill includes data for an un-issued bill in the format of an issued bill.

10. The device of claim 9, wherein the processor is further configured to:
construct an image of a previously-issued bill for presentation on the user device, and
provide a single screen comparison view of the previously-issued bill and the prospective bill.

11. The device of claim 1, wherein, when compiling the real-time data into summary tables, the processor is further configured to:
receive multiple billing feeds with different data standards,
extract data from each of the billing feed files, and
load the data from each of the billing feed files into different tables, where each table corresponds to a particular record type.

12. The device of claim 11, wherein the processor is further configured to:
compare fields in a first file of the multiple billing feeds with a second file of the multiple billing feeds for the same account,
generate a detail report and a summary report of the comparison of the first file and the second file, and
provide, for presentation on the user device, the summary report, wherein the summary report includes links to at least portions of the detailed report.

13. A method performed by one or more devices within a billing operations and certification platform, the method comprising:
receiving, from multiple business processes, real-time billing data relating to the multiple business processes, wherein the multiple business processes include both mainframe systems and open systems;
compiling the real-time billing data into summary tables corresponding to metrics for the multiple business processes;
storing, in a database, the summary tables corresponding to the metrics for the multiple business processes;
receiving, from a user device, a request to present a dashboard user interface including particular charts of the multiple business processes,
retrieving, from one or more of the summary tables corresponding to the metrics for the multiple business processes, data to populate the particular charts for the dashboard user interface, and
providing, to the user device, a configuration interface for presentation of the particular charts for the dashboard user interface,
providing, to the user device, the data to populate the particular charts for the dashboard user interface.

14. The method of claim 13, further comprising:
providing, to the user device, data to present a graphical tracking map for a consolidated billing system, wherein the graphical tracking map tracks bill processing of billing data from a first system through a billing system of a second system.

15. The method of claim 14, further comprising:
providing a selectable link of each particular process flow segment in the graphical tracking map, wherein a user selection of the selectable link causes the one or more devices to provide additional details of the particular process flow segment.

16. The method of claim 13, wherein the summary tables include one or more tables of items that have been flagged for potential billing certification issues in a consolidated billing system for multiple telecommunications services, the process further comprising:
providing, to the user device, data to present a graphical interface for selecting geographical regions for the consolidated billing system, wherein the graphical interface includes links to present a summary of the potential billing certification issues for each of the geographical regions.

17. The method of claim 16, wherein the summary tables include one or more tables of items represent particular metrics for billing certifications in a consolidated billing system for multiple telecommunications services, the process further comprising:
generating a trend preview including one or more charts of the particular metrics for one of the geographical regions.

18. The method of claim 13, further comprising:
comparing fields in a first file of the multiple billing feeds with a second file of the multiple billing feeds for the same account,
generating a detail report and a summary report of the comparison of the first file and the second file, and
providing, for presentation on the user device, the summary report, wherein the summary report includes links to at least portions of the detailed report.

19. A non-transitory computer-readable medium, comprising computer-executable instructions, for causing one or more processors executing the computer-executable instructions to:
receive, from business processes of a consolidated billing system for multiple telecommunications services, real-time billing data relating to the business processes;
compile the real-time billing data into summary tables corresponding to metrics for the business processes;
store, in a database, the summary tables corresponding to the metrics for the business processes;
retrieve, from one or more of the summary tables corresponding to the metrics for the business processes, data to present a graphical tracking map for the consolidated billing system, wherein the graphical tracking map tracks bill processing of a billing data from a first telecommunications service through a billing system of a second telecommunications service; and
provide, to the user device, the data to populate the graphical tracking map.

20. The computer readable medium of claim 19, further comprising computer-executable instructions, for causing one or more processors executing the computer-executable instructions to:
analyze the data to present the graphical tracking map to determine successful process flows and process flows with fallouts; and
provide, in the graphical tracking map, indications of the successful process flows and the process flows with fallouts,
wherein the successful process flows and the process flows with fallouts each include links to enable a user of the user device to access details of the respective process flows.
